(19) United States
(12) Patent Application Publication
(10) Pub. No.: US 2025/0351023 A1
(43) Pub. Date: Nov. 13, 2025

(54) INTER-CU HANDOVER METHOD IN WIRELESS COMMUNICATION SYSTEM, AND APPARATUS FOR THE SAME

(71) Applicant: ELECTRONICS AND TELECOMMUNICATIONS RESEARCH INSTITUTE, Daejeon (KR)

(72) Inventors: Jae Sun CHA, Daejeon (KR); Sung Cheol CHANG, Daejeon (KR)

(21) Appl. No.: 19/202,967

(22) Filed: May 8, 2025

(30) Foreign Application Priority Data
May 9, 2024 (KR) 10-2024-0061425
Aug. 7, 2024 (KR) 10-2024-0105458
Oct. 4, 2024 (KR) 10-2024-0134516
May 7, 2025 (KR) 10-2025-0058957

(51) Int. Cl. H04W 36/00

(52) U.S. Cl. CPC H04W 36/0072; H04W 36/0058

(57) ABSTRACT

A method of a terminal for an inter-CU handover may comprise: receiving candidate cell configuration information for at least one candidate cell from a source cell; performing early uplink synchronization with the at least one candidate cell; transmitting an L1 measurement report for the at least one candidate cell to the source cell; receiving a cell switch command for a target cell among the at least one candidate cell from the source cell based on the L1 measurement report; and performing a random access procedure for the target cell based on the cell switch command to execute the inter-CU handover.

### CROSS-REFERENCE TO RELATED APPLICATIONS

This application claims priority to Korean Patent Application No. 10-2024-0061425, filed on May 9, 2024, No. 10-2024-0105458, filed on Aug. 7, 2024, No. 10-2024-0134516, filed on Oct. 4, 2024, and No. 10-2025-0058957, filed on May 7, 2025, with the Korean Intellectual Property Office (KIPO), the entire contents of which are hereby incorporated by reference.

### BACKGROUND

### 1. Technical Field

The present disclosure relates to a handover method in a wireless communication system, and more particularly, to a method and an apparatus for inter-centralized unit (CU) handover.

### 2. Related Art

A mobile communication system provides radio connectivity to a terminal operating within a predetermined area through a base station connected to a core network. The terminal connects to the core network by exchanging radio data with the connected base station. The moving terminal maintains its connection with the core network by switching the connected base station through a handover. The base station plays a leading role in managing radio resources within a coverage area that provides connectivity to the terminal, and the terminal managed by the base station exchanges data with the base station by transmitting and receiving radio signals within the allowed radio resources.

Currently, the mobile communication system includes a larger number of base stations and network elements due to increasing user mobility and service quality requirements. To address the issues of increased installation and operational costs of the base stations, the architecture has evolved into a distributed base station architecture in which functions of a base station are split into a central unit (CU) and distributed unit(s) (DU(s)). In such a distributed base station architecture, an inter-CU handover is required when user mobility occurs between different CUs. In contrast, during a handover between DUs within the same CU (i.e., an inter-DU handover or intra-CU handover), a single CU may perform all management and control of the base station, thereby enabling efficient processing of the terminal's handover. However, in an inter-CU handover, the switching of the CU responsible for control functions inevitably involves higher layer protocols, which may result in increased handover latency and interruption time compared to the inter-DU handover.

### SUMMARY

The present disclosure for resolving the above-described problems is directed to providing a method and an apparatus for inter-CU handover.

According to an exemplary embodiment of the present disclosure, a method of a terminal for an inter-centralized unit (CU) handover may comprise: receiving candidate cell configuration information for at least one candidate cell from a source cell; performing early uplink synchronization with the at least one candidate cell; transmitting a layer 1 (L1) measurement report for the at least one candidate cell to the source cell; receiving a cell switch command for a target cell among the at least one candidate cell from the source cell based on the L1 measurement report; and performing a random access procedure for the target cell based on the cell switch command to execute the inter-CU handover, wherein a first CU to which the source cell belongs and a second CU to which the target cell belongs are different from each other, new security information is received from the first CU or the second CU when an identifier of a serving cell group to which the source cell belongs and an identifier of a candidate cell group to which the target cell belongs are different, and at least a part of the candidate cell configuration information is maintained in the terminal after completion of the inter-CU handover.

The method may further comprise: after completion of the inter-CU handover, receiving changed candidate cell configuration information for the candidate cell configuration information from the second CU.

The changed candidate cell configuration information may be generated by reflecting changed cell configuration information of a first candidate cell received through a HANDOVER REQUEST ACKNOWLEDGEMENT message in response to a HANDOVER REQUEST message transmitted by the second CU to the first candidate cell among the at least one candidate cell.

The changed candidate cell configuration information may be generated by the second CU transmitting a HANDOVER CANCEL message to a first candidate cell among the at least one candidate cell and receiving a HANDOVER CANCEL ACKNOWLEDGEMENT message to delete the first candidate cell from the candidate cell configuration information.

The new security information may be information received by the second CU from an access and mobility management function (AMF).

The new security information may be received from the first CU by being included in a medium access control (MAC) control element (CE) which is the cell switch command.

The new security information may be received from the second CU through a radio resource control (RRC) signaling after completion of the inter-CU handover.

The new security information may be at least one of a next hop (NH) parameter, a next hop chaining count (NCC), or a pair of (NH, NCC).

The candidate cell configuration information may include at least one of information on a reference configuration commonly applied to the at least one candidate cell, information on at least one candidate cell group into which the at least one candidate cell is grouped, identifier(s) of the at least one candidate cell group, identifier(s) of the at least one candidate cell, or cell configuration information of each of the at least one candidate cell.

Each of the identifier(s) of the at least one candidate cell group may be an identifier of a CU to which each of the at least one candidate cell group belongs or an identifier assigned to each of the at least one candidate cell group.

The method may further comprise: in response to the identifier of the serving cell group to which the source cell belongs being different from the identifier of the candidate cell group to which the target cell belongs, resetting a packet data convergence protocol (PDCP) layer.

According to another exemplary embodiment of the present disclosure, a method of a first centralized unit (CU) to which a source cell belongs, for an inter-CU handover, may comprise: transmitting candidate cell configuration information for at least one candidate cell to a terminal; receiving a layer 1 (L1) measurement report for the at least one candidate cell from the terminal; and transmitting a cell switch command for a target cell among the at least one candidate cell to the terminal based on the L1 measurement report to execute the inter-CU handover, wherein the first CU to which the source cell belongs and a second CU to which the target cell belongs are different from each other, the first CU transmits new security information to the terminal when an identifier of a serving cell group to which the source cell belongs and an identifier of a candidate cell group to which the target cell belongs are different, and at least a part of the candidate cell configuration information is maintained in the terminal after completion of the inter-CU handover.

The new security information may be information received by the second CU from an access and mobility management function (AMF).

The new security information may be transmitted to the terminal by being included in a medium access control (MAC) control element (CE) which is the cell switch command.

The new security information may be at least one of a next hop (NH) parameter, a next hop chaining count (NCC), or a pair of (NH, NCC).

The candidate cell configuration information may include at least one of information on a reference configuration commonly applied to the at least one candidate cell, information on at least one candidate cell group into which the at least one candidate cell is grouped, identifier(s) of the at least one candidate cell group, identifier(s) of the at least one candidate cell, or cell configuration information of each of the at least one candidate cell.

Each of the identifier(s) of the at least one candidate cell group may be an identifier of a CU to which each of the at least one candidate cell group belongs or an identifier assigned to each of the at least one candidate cell group.

According to yet another exemplary embodiment of the present disclosure, a terminal for an inter-centralized unit (CU) handover, may comprise at least one processor, and the at least one processor may cause the terminal to perform: receiving candidate cell configuration information for at least one candidate cell from a source cell; performing early uplink synchronization with the at least one candidate cell; transmitting a layer 1 (L1) measurement report for the at least one candidate cell to the source cell; receiving a cell switch command for a target cell among the at least one candidate cell from the source cell based on the L1 measurement report; and performing a random access procedure for the target cell based on the cell switch command to execute the inter-CU handover, wherein a first CU to which the source cell belongs and a second CU to which the target cell belongs are different from each other, new security information is received from the first CU or the second CU when an identifier of a serving cell group to which the source cell belongs and an identifier of a candidate cell group to which the target cell belongs are different, and at least a part of the candidate cell configuration information is maintained in the terminal after completion of the inter-CU handover.

The new security information may be received from the first CU by being included in a medium access control (MAC) control element (CE) which is the cell switch command.

The at least one processor may further cause the terminal to perform: in response to the identifier of the serving cell group to which the source cell belongs being different from the identifier of the candidate cell group to which the target cell belongs, resetting a packet data convergence protocol (PDCP) layer.

According to exemplary embodiments of the present disclosure, by introducing a layer ½-based mobility (LTM) trigger structure for an inter-CU handover, successive cell switching of a terminal can be efficiently supported, and signaling overhead caused by repetitive handover preparation procedures can be reduced by maintaining candidate cell configuration information even after the handover. In addition, by pre-allocating a security context or flexibly updating the security context in accordance with a handover timing, a handover procedure delay can be minimized while maintaining security. Furthermore, also in a dual connectivity (DC) structure, a handover between a master node and a secondary node can be flexibly handled, thereby improving overall connection stability and service continuity of the system.

### BRIEF DESCRIPTION OF DRAWINGS

FIG. 1 is a conceptual diagram illustrating an exemplary embodiment of a wireless communication network

FIG. 2 is a block diagram illustrating an exemplary embodiment of a communication node constituting a wireless communication network.

FIG. 3 is a diagram illustrating (an example of) connections between base stations and a core network in a wireless communication network using base stations having a distributed structure.

FIGS. 4A and 4B are sequence charts for describing an inter-CU handover procedure proposed in the present disclosure.

FIG. 5 is a conceptual diagram illustrating an example of cell deployment and terminal movement for describing a change of an LTM candidate cell configuration.

FIG. 6 is a sequence chart for describing a procedure of changing an LTM candidate cell configuration according to an exemplary embodiment of the present disclosure.

FIG. 7 is a sequence chart for describing a procedure of updating an LTM candidate cell configuration according to another exemplary embodiment of the present disclosure.

FIG. 8 is a sequence chart for describing a procedure for updating a security context according to an exemplary embodiment of the present disclosure.

FIGS. 9 to 11 are sequence charts for describing a procedure for applying pre-allocated multiple pieces of security information to successive inter-CU handovers according to another exemplary embodiment of the present disclosure.

FIG. 12 is a conceptual diagram for describing a method of optimizing definition of an LTM candidate cell configuration according to an exemplary embodiment of the present disclosure.

FIGS. 13A and 13B and FIGS. 14A and 14B are sequence charts for describing an inter-CU handover procedure under a condition that a CU operates as an MN according to exemplary embodiments of the present disclosure.

FIGS. 15A and 15B and FIGS. 16A and 16B are sequence charts for describing an inter-CU handover procedure without changing an MN under a condition that a CU operates as an SN, according to exemplary embodiments of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication network may include a terrestrial network and a non-terrestrial network. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In other words, “an operation (e.g., transmission operation) is configured in a communication node” may mean that the communication node receives “configuration information (e.g., information elements, parameters) for the operation” and/or “information indicating to perform the operation”. “An information element (e.g. parameter) is configured in a communication node” may mean that “the information element is signaled to the communication node (e.g. the communication node receives the information element)”.

The signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)). A signaling message may be at least one of an SI signaling message (e.g., SI message), an RRC signaling message (e.g., RRC message), a MAC CE signaling message (e.g., MAC CE message or MAC message), or a PHY signaling message (e.g., PHY message).

A wireless communication network to which exemplary embodiments according to the present disclosure are applied will be described. A wireless communication network to which exemplary embodiments according to the present disclosure are applied is not limited to the contents described below, and exemplary embodiments according to the present disclosure may be applied to various wireless communication networks. Here, the wireless communication network may be used as the same meaning as a wireless communication system.

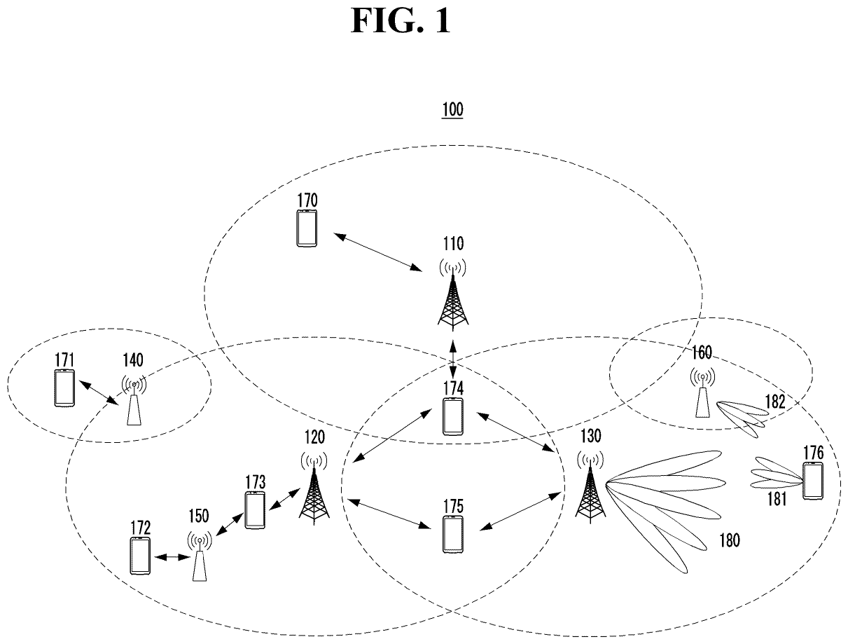

FIG. 1 is a conceptual diagram illustrating an exemplary embodiment of a wireless communication network.

Referring to FIG. 1, a mobile communication network 100 may comprise a plurality of communication nodes 110, 120, 130, 140, 150, 160, 170, 171, 172, 173, 174, 175, and 176. Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a space division multiple access (SDMA) based communication protocol, or the like.

The mobile communication network 100 may comprise a plurality of base stations (BSs) 110, 120, 130, 140, 150 and 160, and a plurality of terminals (user equipments (UEs)) 170, 171, 172, 173, 174, 175, and 176. Each of the plurality of base stations 110, 120, and 130 may form a macro cell. Alternatively, each of the plurality of base stations 140, 150, and 160 may form a small cell. The plurality of terminals 170 and 174 may belong to a cell coverage of the base station 110. The plurality of base stations 140 and 150 and the plurality of terminals 172, 173, 174, and 175 may belong to a cell coverage of the base station 120. The base station 160 and the plurality of terminals 174, 175, and 176 may belong to a cell coverage of the base station 130.

Each of the plurality of communication nodes 110, 120, 130, 140, 150, 160, 170, 171, 172, 173, 174, 175, and 176 may support a radio access protocol specification of a radio access technology based on cellular communication (e.g., long term evolution (LTE), LTE-Advanced (LTE-A), new radio (NR), etc. which are defined in the 3rd generation partnership project (3GPP) standard). Each of the plurality of base stations 110, 120, 130, 140, 150, and 160 may operate in a different frequency band, or may operate in the same frequency band. The plurality of base stations 110, 120, 130, 140, 150, and 160 may be connected to each other through an ideal backhaul or a non-ideal backhaul, and may exchange information with each other through the ideal backhaul or the non-ideal backhaul. Each of the plurality of base stations 110, 120, 130, 140, 150, and 160 may be connected to a core network (not shown) through a backhaul. Each of the plurality of base stations 110, 120, 130, 140, 150, and 160 may transmit data received from the core network to the corresponding terminals 170, 171, 172, 173, 174, 175, and 176, and transmit data received from the corresponding terminals 170, 171, 172, 173, 174, 175, and 176 to the core network.

Each of the plurality of communication nodes 110, 120, 130, 140, 150, 160, 170, 171, 172, 173, 174, 175, and 176 constituting the mobile communication network 100 may exchange signals with a counterpart communication node without interferences by using beams 180, 181, and 182 formed through a beamforming function using multiple antennas.

Each of the plurality of base stations 110, 120, 130, 140, 150, and 160 may support multiple input multiple output (MIMO) transmissions using multiple antennas (e.g., single user (SU)-MIMO, multi user (MU)-MIMO, massive MIMO, etc.), coordinated multipoint (CoMP) transmission, carrier aggregation (CA) transmission, unlicensed band transmission, device-to-device (D2D) communication, proximity services (ProSe), dual connectivity transmission, and the like.

Each of the plurality of base stations 110, 120, 130, 140, 150, and 160 may be referred to as a NodeB, evolved NodeB, gNB, ng-eNB, radio base station, access point, access node, node, radio side unit (RSU), or the like. Each of the plurality of terminals 170, 171, 172, 173, 174, 175, and 176 may be referred to as a user equipment (UE), terminal, access terminal, mobile terminal, station, subscriber station, mobile station, portable subscriber station, node, device, Internet of Things (IoT) device, mounted apparatus (e.g., mounted module/device/terminal or on-board device/terminal, etc.), or the like. The content of the present disclosure is not limited to the above-mentioned terms, and they may be replaced with other terms that perform the corresponding functions according to a radio access protocol according to a radio access technology (RAT) and a functional configuration supporting the same.

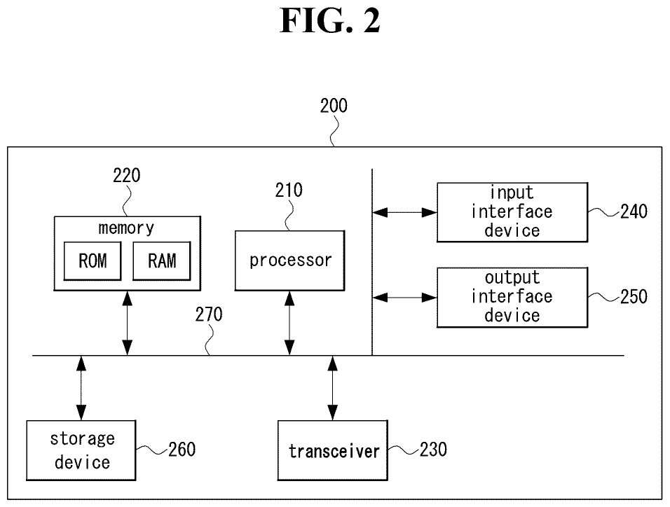

FIG. 2 is a block diagram illustrating an exemplary embodiment of a communication node constituting a wireless communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with exemplary embodiments of the present invention are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Each of the plurality of communication nodes 110, 120, 130, 140, 150, 160, 170, 171, 172, 173, 174, 175, and 176 constituting the wireless communication network 100 and a plurality of communication nodes described in the present disclosure may be implemented in the form of the communication node 200.

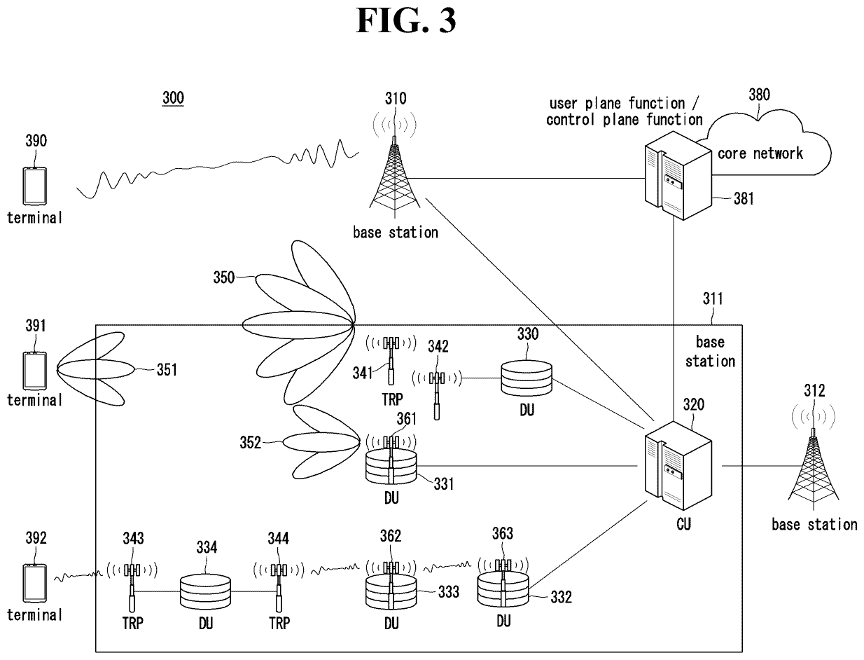

FIG. 3 is a diagram illustrating (an example of) connections between base stations and a core network in a wireless communication network using base stations having a distributed structure.

Referring to FIG. 3, in a wireless communication network, base stations 310, 311, and 312 may be connected to an end node 381 of a core network 380 through a backhaul, and may transfer data exchanged between the plurality of terminals 390, 391, and 392 and the core network 380 in both directions. The core network 380 may correspond to a 4G core network supporting 4G communication or a 5G core network supporting 5G communication. Here, the core network 380 supporting 4G communication may include a mobility management entity (MME), a serving-gateway (S-GW), a packet data network (PDN)-gateway (P-GW), and the like. The core network 380 supporting 5G communication may include an access and mobility management function (AMF) entity, a user plane function (UPF) entity, a P-GW, and the like.

Here, the end node 381 of the core network 380 may provide a user plane function for exchanging packets with the plurality of terminals 390, 391, and 392 and a control plane function for managing access and mobility of the terminals. The user plane function may be a S-GW, a UPF, or the like. The control plane function may be an MME, an AMF, or the like. The present disclosure is not limited by the terms ‘S-GW’, ‘UPF’, ‘MME’, and ‘AMF’, and the terms may be replaced with other terms indicating the corresponding functions according to a radio access protocol of a radio access technology (RAT) or entities performing the corresponding functions according to constituent functions of the core network.

Unlike a centralized architecture base station that provides all radio access protocol functions within a single base station, the base station 311 composed of a set of distributed devices configured by splitting the functions of the radio access protocol may include a central unit (CU) 320 with a centralized function, a plurality of distributed units (DUs) 330, 331, 332, 333, and 334 with distributed functions, and a plurality of transmission and reception points (TRPs) 341, 342, 343, 344, 361, 362, and 363 for transmitting and receiving signals. In FIG. 3, only the base station 311 is shown as a base station having a distributed structure, but the other base stations 310 and 312 may also be configured identically or similarly to the base station 311 having a distributed structure.

The CU 320, which includes upper functions of the radio access protocol, may be connected to the plurality of DUs 330, 331, 332, 333, and 334 in the direction of a radio section, and may be connected to the end node 381 in the direction of the core network 380. In addition, the CU 320 may be connected to the plurality of neighboring base stations 310 and 312. Each of the plurality of DUs 331, 332, and 333 which include lower functions of the radio access protocol may be connected to the plurality of TRPs 361, 362, and 363 located at the same geographical location, and each of the plurality of DUs 330 and 334 may be connected to the plurality of TRPs 341, 342, 343, and 344 located at remote locations.

Each of the plurality of base stations 310, 311, and 312 may include a plurality of TRPs for transmitting and receiving radio signals, and may use data detected from signals transmitted and received by the TRPs. Each of the plurality of TRPs 341, 342, 343, 344, 361, 362, and 363 may operate independently or in cooperation with neighboring TRPs. Each of the plurality of TRPs 341 and 361 may exchange signals with a counterpart communication node without interference through a plurality of beams 350 and 352 formed based on a beamforming function using multiple antennas. Each of the plurality of TRPs 341, 342, 343, 344, 361, 362, and 363 may refer to a (remote) radio transceiver, remote radio head (RRH), wireless antenna, transmission point (TP), transmission and reception point (TRP), or the like.

Each of the plurality of DUs 330, 331, 332, 333, and 334 may be wired or wirelessly connected to a communication node in the direction of the core network 380. Each of the plurality of DUs 330, 331, and 332 wired to the communication node in the direction of the core network 380 may configure some functions of the radio access protocol of the base station in the radio section to provide radio access to at least one terminal, and may be connected to the CU 320 in a wired section. Each of the plurality of DUs 333 and 334 wirelessly connected to the communication node in the direction of the core network 380 may configure some functions of the radio access protocol of the base station in the radio section to provide radio access to at least one terminal, and may configure some functions of the radio access protocol of the terminal in the radio section to wirelessly connect to a relay device in the direction of the CU 320, thereby being connected to the CU 320 in both directions.

For example, the DU 333 may wirelessly connect to the DU 332 in the direction of the CU 320. Therefore, the DU 332 may be a relay device that relays the connection between the DU 333 and the CU 320. The DU 334 may wirelessly access the DU 333 in the direction of the CU 320. Therefore, the DU 333 may be a relay device that relays the connection between the DU 334 and the CU 320. The plurality of TRPs 343 and 344 connected to the DU 334 may form a beam or may be configured in a region where interference is reduced by a physical method. The TRP 341 may configure some functions of the base station radio access protocol, and the TRP 342 may configure some functions of the terminal radio access protocol.

When a plurality of communication nodes exchange signals using a plurality of beams 350, 351, and 352 formed by the respective communication nodes, each communication node may exchange signals through a beam paired (configured) with a counterpart node. To this end, a plurality of beams of the counterpart communication node are searched, reception strength of each beam is measured, and at least one beam for exchanging signals may be configured based on selection by a communication node participating in communication. A quality of a radio channel can be maintained by changing the beam of the communication node to correspond to a change of a radio channel state or the movement of the communication node.

Hereinafter, a structure and layer-specific functions of a radio access protocol that provides a radio connection between a base station and a terminal in a wireless communication network will be described. The structure of the radio access protocol and the functions of each layer are described for the purpose of describing specific exemplary embodiments only, and are not intended to limit the contents of the present disclosure, and include changes or substitutions included in the concept and technical scope of the proposed techniques.

The radio access protocol may provide functions in which a plurality of communication nodes exchange data and control information by using radio resources in a radio section, and may be hierarchically configured. In the cellular communication (e.g., long term evolution (LTE), LTE-Advanced (LTE-A), new radio (NR), etc. which are the 3rd generation partnership project (3GPP) standards), the radio access protocol may include a radio layer 1 (RL1) which configures physical signals; a radio layer 2 (RL2) which controls radio transmissions in radio resources shared by a plurality of communication nodes, transmits data to a counterpart node, and converges data from the counterpart node; and a radio layer 3 (RL3) which performs radio resource managements such as network information sharing, radio connection management, mobility management, and quality of service (QOS) management for multiple communication nodes participating in the mobile network.

The radio layer 1 may be a physical layer and may provide functions for data transfer. The radio layer 2 may include sublayers such as a medium access control (MAC), a radio link control (RLC), a packet data convergence protocol (PDCP), a service data adaptation protocol (SDAP), and the like. The radio layer 3 may be a radio resource control (RRC) layer, and may provide an AS layer control function.

Operations such as a start, stop, reset, restart, or expire of a timer defined in relation to an operation of the timer defined or described in the present disclosure may mean or include the operation of the timer or a counter for the corresponding timer without being separately described.

Hereinafter, operation methods of communication nodes in a mobile communication network according to exemplary embodiments of the present disclosure will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

### [Inter-CU Handover Procedure]

An inter-CU handover procedure occurring when a terminal (e.g. UE) moves from an area of one CU to an area of another CU in a wireless communication network composed of base stations having a distributed architecture is described. In the present disclosure, for convenience of description, the inter-CU handover procedure is described based on L1/L2 triggered mobility (LTM) as defined in cellular communication (e.g. 3GPP technical specifications). LTM is a technique for handover between DUs within the same CU (i.e. intra-CU or inter-DU handover) in a wireless communication network having a distributed base station architecture, and is merely described for a purpose of describing a specific exemplary embodiment, not intended to limit various exemplary embodiments of the present disclosure.

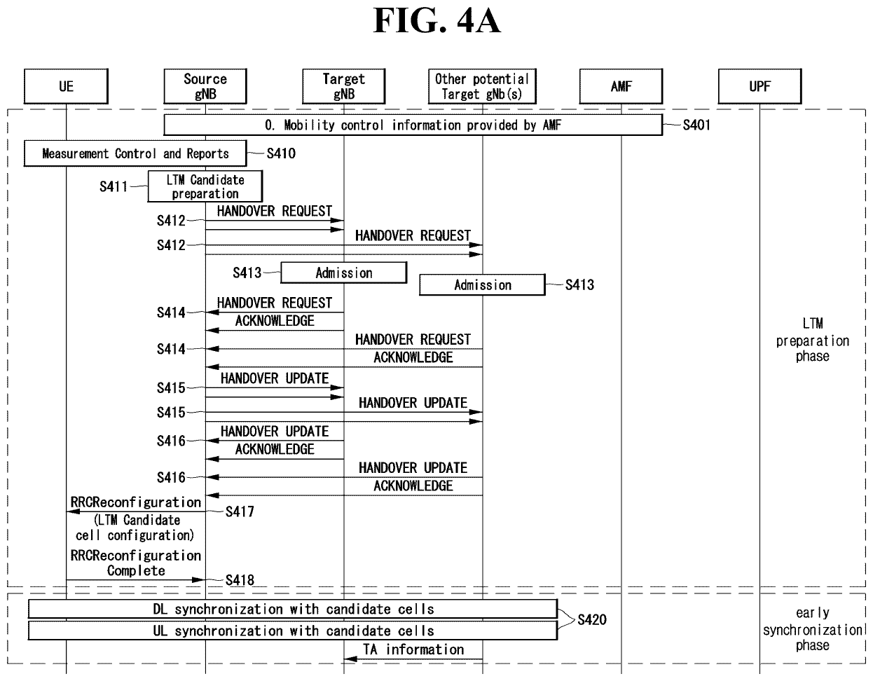

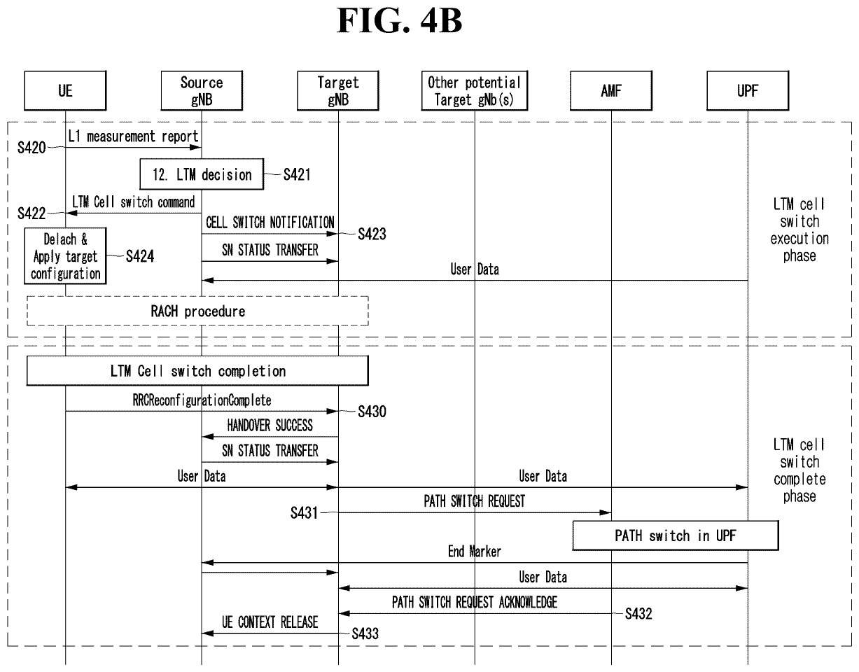

FIGS. 4A and 4B are sequence charts for describing an inter-CU handover procedure proposed in the present disclosure.

In FIGS. 4A and 4B, ‘gNB’ may be used with the same meaning as ‘centralized unit’ or ‘CU,’ and a subject that determines and performs specific functions is not limited to a gNB but the term is used to refer to a physical entity. Determination and execution of inter-CU handover may be performed at a CU or DU level. Hereinafter, ‘cell’ refers to a radio cell provided by a DU or a TRP within a CU.

Referring to FIG. 4A, when a terminal (e.g. UE) is connected to a source gNB, the source gNB configures information for mobility control of the terminal through an AMF (S401). Based on the configured information, the source gNB configures a radio measurement procedure of the terminal, and the terminal measures signals of the source gNB and candidate target gNBs according to the measurement configuration and reports results to the source gNB (S410). Upon receiving a measurement report message, the source gNB determines whether to use inter-CU LTM (S411) and transmits a HANDOVER REQUEST message to each of one or more candidate cells to request an inter-CU handover (S412). Since the HANDOVER REQUEST message is transmitted per candidate cell, when a candidate gNB manages multiple cells, multiple HANDOVER REQUEST messages may be delivered to respective candidate cells through the same candidate gNB. Each candidate cell determines whether to admit the handover request based on terminal information and connection information included in the HANDOVER REQUEST message, and its own cell configuration information (S413), and transmits a HANDOVER REQUEST ACKNOWLEDGE message including an admission status and configuration information of the candidate cell to the source gNB as a response (S414). Upon receiving the HANDOVER REQUEST ACKNOWLEDGE messages from all candidate cells, the source gNB determines final candidate cells based on the information received from the candidate cells, and, if necessary, updates candidate cell configuration information received from the candidate cells. For example, the source gNB may change the candidate cell configuration information so that radio resources (e.g. CSI-RS) required for the terminal to measure radio channels of the candidate cells are allocated identically among all candidate cells. The source gNB transmits a HANDOVER UPDATE message to each of the candidate cells to deliver the determination on the final candidate cells and the updated candidate cell configuration information (S415), and each of the candidate cells receiving the HANDOVER UPDATE message transmits a HANDOVER UPDATE ACKNOWLEDGE message in response (S416). The HANDOVER UPDATE message may be transmitted for a purpose of canceling a handover for a candidate cell that is not included in the final candidate cells. Alternatively, a HANDOVER CANCEL message may be transmitted instead of the HANDOVER UPDATE message to cancel the handover. Furthermore, the source gNB may transmit the updated candidate cell configuration information only to a target cell through a CELL SWITCH NOTIFICATION message immediately after cell switching to the target cell is determined, and in this case, cell configuration information of candidate cells other than the target cell may not be shared with the candidate cells other than the target cell.

The source gNB transmits an LTM candidate cell configuration including cell configuration information of each candidate cell to the terminal through an RRCReconfiguration message (S417), and the terminal transmits an RRCReconfigurationComplete message in response (S418). The candidate cells included in the LTM candidate cell configuration transmitted by the source gNB may correspond to DUs or TRPs connected to the source gNB, and/or may correspond to DUs or TRPs belonging to another gNB.

The terminal may perform downlink and uplink synchronization procedures in advance with the respective candidate cells included in the LTM candidate cell configuration before an LTM cell switch execution phase (S420). Particularly, the terminal may acquire an early timing advance (TA) for each of the candidate cells according to a procedure and scheme configured by the network. This procedure is initiated by a PDCCH order from the source gNB, and subsequently, the terminal transmits a preamble to each candidate cell based on random access information (e.g. TA execution time, preamble, etc.) included in the PDCCH order. In a general random access procedure, the terminal waits to receive a random access response (RAR) message transmitted by the candidate cell to obtain a TA value. However, in this case, the terminal does not wait for a random access response, and immediately resumes uplink and downlink transmission and reception operations with the source cell after transmitting the preamble. The candidate cell receiving the preamble transmitted by the terminal calculates a TA value and deliver the calculated TA value to the source gNB. The source gNB includes the received TA value in a cell switch command MAC CE that is transmitted to the terminal during the LTM cell switch execution phase. On the other hand, the terminal may autonomously perform early TA acquisition for each candidate cell without assistance from the network, and in this case, the terminal calculates the TA for each candidate cell by receiving a random access response.

Referring to FIG. 4B, the terminal performs L1 measurement on each candidate cell included in the LTM candidate configuration and transmits an L1 measurement report to the source gNB (S420). The source gNB determines a target cell based on the received L1 measurement report (S421), and transmits a cell switch command MAC CE including an LTM candidate cell identifier of the target cell to the terminal to request cell switching to the target cell (S422). The source gNB, after transmitting the cell switch command MAC CE to the terminal, transmits a CELL SWITCH NOTIFICATION message to the target cell to notify cell switching of the terminal (S423). The target cell, upon receiving the CELL SWITCH NOTIFICATION message, initiates preparations to support the cell switching of the terminal, such as allocating radio resources for random access. The terminal switches to the target cell and applies a candidate cell configuration designated by the LTM candidate cell identifier (S424). If the terminal does not possess a valid TA for the target cell, the terminal may perform a random access procedure for the target cell.

The terminal transmits an RRCReconfigurationComplete message to the target cell to complete the LTM cell switch procedure (S430). The target gNB, upon determining successful completion of the LTM cell switching, transmits a PATH SWITCH REQUEST message to the AMF to switch a downlink data path (S431), and upon receiving a PATH SWITCH REQUEST ACKNOWLEDGE message from the AMF, the downlink path switching is completed (S432). The downlink path switching occurs only in a handover between different CUs, i.e., when the target cell belongs to a target gNB (i.e. CU) different from the source gNB (i.e. CU). Upon receiving the PATH SWITCH REQUEST ACKNOWLEDGE message from the AMF, the target gNB transmits a UE CONTEXT RELEASE message to the source gNB to request release of all information on the terminal (S433).

In a general handover procedure, the candidate cell information and terminal information configured during a handover preparation phase are released after completion of the handover, and for subsequent handovers, the handover preparation phase needs to be performed again to newly configure candidate cell information. However, in the inter-CU handover proposed in the present disclosure, the terminal maintains the LTM candidate cell configuration configured in the LTM preparation phase even after the completion of the LTM cell switching, and uses the preconfigured LTM candidate cell configuration for subsequent LTM handovers. Since the source cell is also changed to a candidate cell after the LTM cell switching and may become a target cell in future LTM handovers, the source cell may retain some essential information of the terminal without releasing all information.

### [Change of Candidate Cell Configuration]

In the inter-CU handover proposed in the present disclosure, the LTM candidate cell configuration configured in the handover preparation phase is maintained for subsequent handovers. However, as the terminal moves, the previously configured LTM candidate cell configuration may need to be changed.

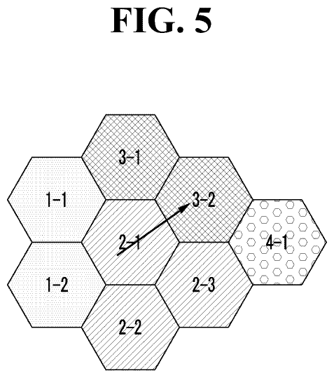

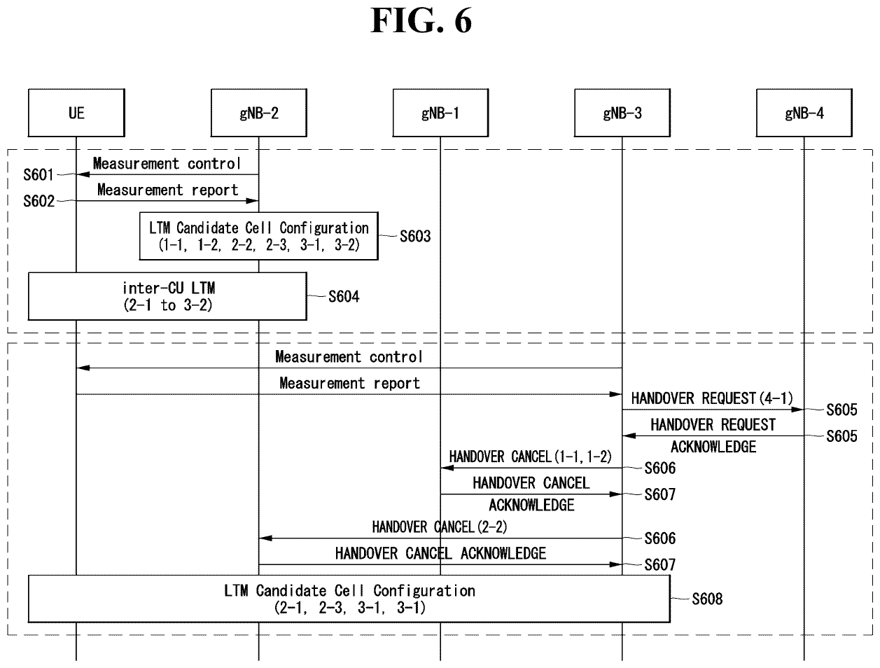

FIG. 5 is a conceptual diagram illustrating an example of cell deployment and terminal movement for describing a change of an LTM candidate cell configuration, and FIG. 6 is a sequence chart for describing a procedure of changing an LTM candidate cell configuration according to an exemplary embodiment of the present disclosure.

Referring to FIG. 5, a situation is assumed in which a total of eight cells are deployed. Cells 1-1 and 1-2 are connected to a CU 1, cells 2-1, 2-2, and 2-3 are connected to a CU 2, cells 3-1 and 3-2 are connected to a CU 3, and a cell 4-1 is connected to a CU 4, respectively. The current source cell of the terminal is the cell 2-1, and an inter-CU handover to the cell 3-2 may be performed according to movement of the terminal.

Referring to FIG. 6, for convenience, a subject that determines the handover is described as a CU (e.g. gNB-1, gNB-2, etc.). However, determination and execution of the inter-CU handover may be performed at a CU or DU level. In addition, ‘cell’ refers to a radio cell provided by a DU or a TRP within a CU.

The terminal may report measurements to the source cell by measuring signals of the source cell and neighboring cells according to a radio measurement configuration configured by the source cell (S601, S602). Upon receiving the measurement report message, the source cell may determine to apply an inter-CU handover and generate an LTM candidate cell configuration to transmit to the terminal (S603). The LTM candidate cell configuration transmitted at this time may include information on the cells 1-1, 1-2, 2-2, 2-3, 3-1, and 3-2. The source cell may determine the cell 3-2 as a target cell among the LTM candidate cells, and the terminal may perform an inter-CU handover to the cell 3-2 according to a request from the source cell (S604).

After successfully completing the inter-CU handover, the terminal may perform a radio measurement and reporting procedure according to the previously configured radio measurement configuration or a radio measurement configuration newly configured by the new source cell. The new source cell, the cell 3-2 (i.e. gNB-3), may determine to change the LTM candidate cell configuration. For example, the cell 3-2 (i.e. gNB-3) may add the cell 4-1 to the LTM candidate cell configuration through an exchange of HANDOVER REQUEST and HANDOVER REQUEST ACKNOWLEDGE messages, as in the LTM preparation phase shown in FIG. 4A (S605).

Meanwhile, the cell 3-2 may determine to delete the cells 1-1, 1-2, and 2-2 (i.e. cells of gNB-1 and gNB-2) from the LTM candidate cell configuration to prevent unnecessary measurements and uplink/downlink pre-synchronization of the terminal. For deletion from the LTM candidate cell configuration, the cell 3-2 may transmit HANDOVER CANCEL messages to the cells 1-1, 1-2, and 2-2 (S606). Upon receiving the HANDOVER CANCEL message, each of the cells 1-1, 1-2, and 2-2 may transmit a HANDOVER CANCEL ACKNOWLEDGE message to the cell 3-2 in response and delete the terminal information (S607). The cell 3-2 may transmit an RRCReconfiguration message including the newly configured LTM candidate cell configuration to the terminal and terminate the candidate cell configuration change procedure (S608).

The inter-CU handover proposed in the present disclosure may perform successive cell switching among candidate cells while maintaining the LTM candidate cell configuration for a relatively long time compared to a general handover. During the maintenance of the LTM candidate cell configuration, addition, deletion, or change of a protocol data unit (PDU) session may occur. Particularly, when addition or change of a PDU session occurs, it may be required to identify whether all existing candidate cells are able to support the added or changed PDU session. Candidate cells that are not able to support the added or changed PDU session need to be deleted from the LTM candidate cell configuration. In addition, when a PDU session is deleted, the deletion of the PDU session may be notified to all candidate cells to request release of radio resources for the deleted PDU session.

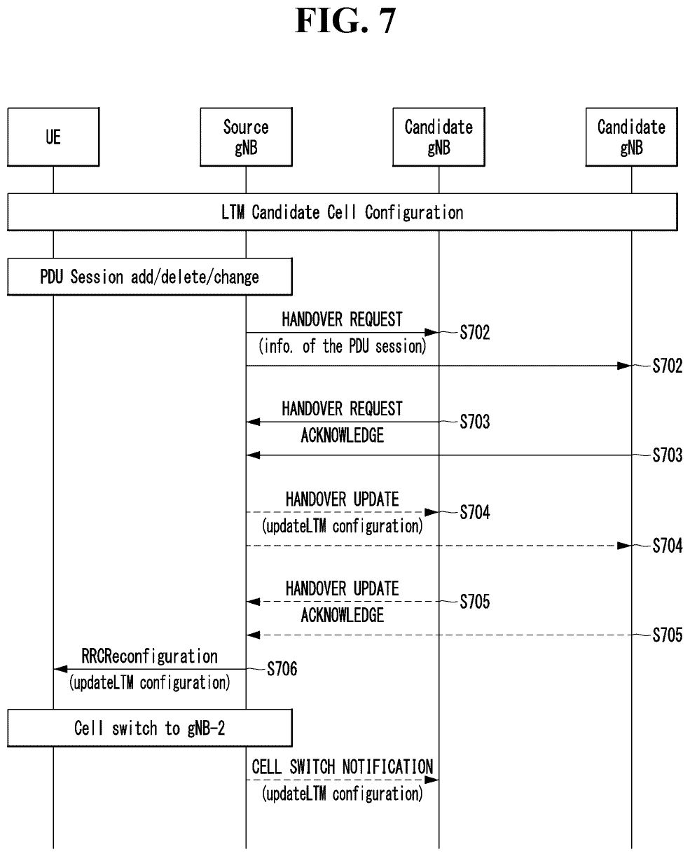

FIG. 7 is a sequence chart for describing a procedure of updating an LTM candidate cell configuration according to another exemplary embodiment of the present disclosure.

Referring to FIG. 7, a procedure in which a candidate cell configuration is updated when a change occurs in a currently configured PDU session is illustrated. When a PDU session is added or changed (S701), the source gNB may transmit a HANDOVER REQUEST message to the candidate gNBs to request support for the added or changed PDU session (S702). Each candidate gNB that receives the HANDOVER REQUEST message may determine whether to support the added or changed PDU session through its own admission control function. When the support is available, each candidate gNB may reserve resources for the support of the PDU session. Each candidate cell may transmit a HANDOVER REQUEST ACKNOWLEDGE message including a result on whether to approve the HANDOVER REQUEST message to the source gNB (S703). The same procedure may be applied when a PDU session is deleted. However, in this case, the candidate gNB receiving the HANDOVER REQUEST message may not need to perform admission control, but rather release radio resources associated with the deleted PDU session and transmit a HANDOVER REQUEST ACKNOWLEDGE message to the source gNB.

Upon receiving the HANDOVER REQUEST ACKNOWLEDGE messages from all candidate gNBs, the source gNB may update the LTM candidate cell configuration based on the received information, and transmit the updated information to the candidate gNBs through HANDOVER UPDATE messages (S704). Each candidate gNB receiving the HANDOVER UPDATE message may update its existing LTM candidate cell configuration to the configuration included in the HANDOVER UPDATE message and transmit a HANDOVER UPDATE ACKNOWLEDGE message to the source gNB (S705). Meanwhile, the source gNB may include the updated LTM candidate cell configuration in an RRCReconfiguration message and transmit the RRCReconfiguration message to the terminal (S706), and the terminal may update the previously stored LTM candidate cell configuration to the configuration included in the received RRCReconfiguration message.

In the present exemplary embodiment, the procedure for updating the LTM candidate cell configuration using two types of messages (i.e. HANDOVER REQUEST message and HANDOVER UPDATE message) has been described, but the procedure may also be performed using only one type of message. For example, a handover update indicator may be added to the HANDOVER REQUEST message, and depending on a value set in the handover update indicator, it may be determined whether the message is for a handover request, for a update request for the LTM candidate cell configuration, or for sharing the updated LTM candidate cell configuration.

In addition, the updated LTM candidate cell configuration may be shared with all candidate gNBs before a cell switching occurs, or may be shared only with a target cell at a time of cell switching. As shown in FIG. 7, the updated LTM candidate cell configuration may be shared with all candidate gNBs through exchange of HANDOVER UPDATE and HANDOVER UPDATE ACKNOWLEDGE messages before a cell switching, or may be included in a CELL SWITCH NOTIFICATION message and shared only with the target cell at the time of cell switching.

### [Identification of CUs and DUs]

In the LTM preparation phase of FIG. 4A, the generated LTM candidate cell configuration may include candidate cell(s) belonging to the CU to which the source cell belongs, or may include candidate cell(s) belonging to CU(s) different from that of the source cell. Among the candidate cells included in the LTM candidate cell configuration, the final target cell may be determined by the source cell or the source gNB based on the terminal's radio measurement report, and the LTM cell switch command MAC CE transmitted to the terminal may include information for identifying the determined target cell.

The identifier information that identifies the target cell among the candidate cells included in the LTM candidate cell configuration may be an LTM candidate cell identifier included in each candidate cell configuration. In this case, the LTM candidate cell identifier may be an identifier that uniquely identifies the candidate cell or candidate cell configuration included in the LTM candidate cell configuration, regardless of a type of the cell (i.e. whether the cell is within the same CU or a different CU). The LTM candidate cell identifier may be defined as a single identifier, or may be defined as a combination of two indexes used to identify the target cell. For example, a unique identification may be achieved by combining an identifier (i.e. index) for identifying a CU to which the candidate cell belongs and an index for identifying the cell (i.e. DU or TRP) within that CU. In this case, both indexes are included in the LTM cell switch command MAC CE.

In case of a CU identifier, an identifier that uniquely identifies a CU in the entire network may be used, or an identifier for a purpose of distinguishing a CU to which each candidate cell in the LTM candidate cell configuration belongs may be used. For example, if an identifier of a CU to which a serving cell belongs is set to 1, an identifier of a CU to which a candidate cell A belongs is set to 1, and an identifier of a CU to which a candidate cell B belongs is set to 2, 1 and 2 do not necessarily uniquely identify the CUs in the entire network, but rather indicate only that the CU to which the serving cell and the candidate cell A belong is different from the CU to which the candidate cell B belongs.

As another method for identifying an LTM candidate cell, a physical cell identifier (i.e. physical cell ID), which is a unique identifier assigned to each cell, may be included in the LTM cell switch MAC command CE and used as identifier information to identify the candidate cell or candidate configuration.

### [Update of Security Context]

In a base station having a distributed architecture, functions of the base station are operated by being split into a CU and DU(s). Generally, a physical layer function, MAC sublayer function, and RLC sublayer function are located in the DU, and a PDCP sublayer function is located in the CU. In a handover between DUs connected to the same CU (i.e. intra-CU handover), since the CU having a PDCP sublayer function responsible for security does not change, it is not necessary to update a security context after the handover. However, in case of an inter-CU handover, since the CU connected to the source cell is different from the CU connected to the target cell, the security context needs to be updated to maintain security in the target cell.

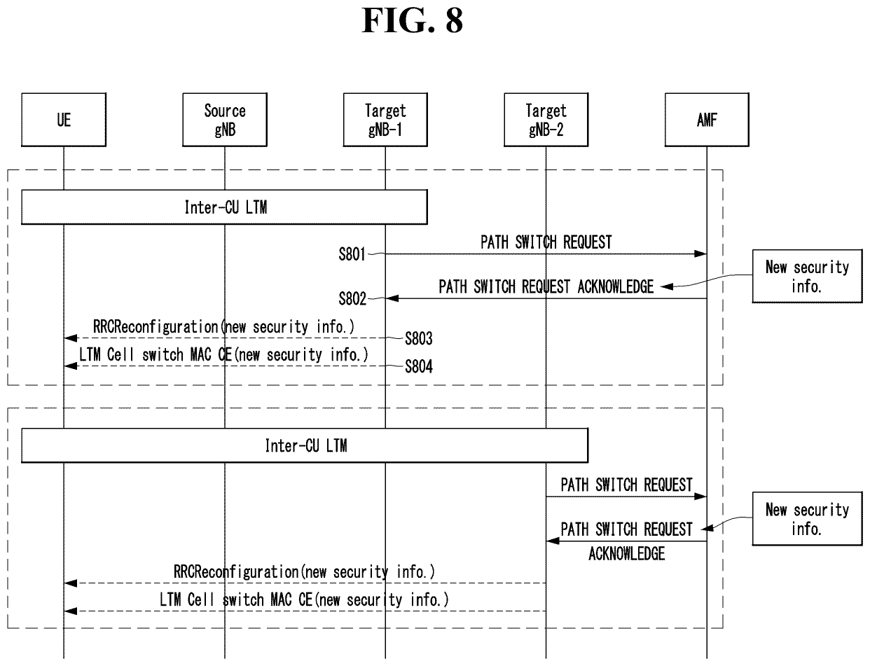

FIG. 8 is a sequence chart for describing a procedure for updating a security context according to an exemplary embodiment of the present disclosure.

A security context may be managed by a CU, and a update procedure of the security context is required only when the CU is switched. Therefore, when describing the security context update procedure, functions and procedures may be described at a gNB level rather than a cell level. When an inter-CU handover is completed, the target gNB may transmit a PATH SWITCH REQUEST message to the AMF to switch a downlink data path (S801), and the AMF may transmit a PATH SWITCH REQUEST ACKNOWLEDGE message to the target gNB after switching the downlink data path (S802). The PATH SWITCH REQUEST ACKNOWLEDGE message may include new security information to be used at a next inter-CU handover by a new target gNB. The new security information may be a next hop (NH) parameter, a next hop chaining count (NCC), or a pair of (NH, NCC). A new source gNB may deliver the new security information received from the AMF to the terminal through an RRCReconfiguration message before executing a next inter-CU handover (S803). In the present exemplary embodiment, the RRCReconfiguration message is used as a means for delivering the new security information, but another control message transmitted by the source gNB to the terminal may be used to deliver the new security information. Alternatively, the new security information may be included in the LTM cell switch command MAC CE and transmitted to the terminal during the execution phase of the inter-CU handover (S804).

In the security context update procedure shown in FIG. 8, new security information may be allocated by the AMF for each inter-CU handover and applied for each inter-CU handover. Alternatively, multiple pieces of security information may be pre-allocated and applied to a series of inter-CU handovers occurring subsequently. For example, a list of NCC values may be pre-allocated during the preparation phase for inter-CU handover, and one NCC value from the list may be used each time an inter-CU handover occurs.

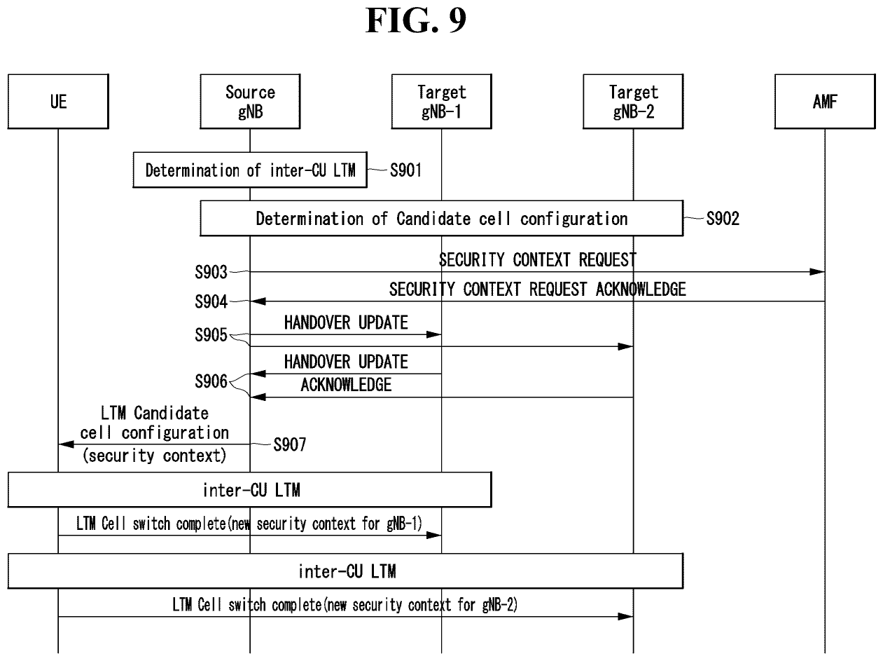

FIGS. 9 to 11 are sequence charts for describing a procedure for applying pre-allocated multiple pieces of security information to successive inter-CU handovers according to another exemplary embodiment of the present disclosure.

Referring to FIG. 9, a source gNB that has determined to perform an inter-CU handover (S901) may determine an LTM candidate cell configuration through signal message exchange with neighboring gNBs (S902). Then, the source gNB may transmit a SECURITY CONTEXT REQUEST message to the AMF to request new security information for each candidate cell included in the LTM candidate cell configuration (S903). The AMF may allocate new security information for each candidate cell included in the LTM candidate cell configuration and transmit a SECURITY CONTEXT ACKNOWLEDGE message including the allocated security information to the source gNB (S904).

Since the update of the security context is only required when a CU is switched, the AMF may allocate security information per CU. For example, if the number of candidate cells is 10 and the number of CUs to which the candidate cells are connected is 5, the AMF may allocate 5 pieces of new security information in total, one per CU. The new security information may be one piece of per-CU security information (e.g. one NCC or one pair of {HN, NCC}), or multiple pieces of per-CU security information (e.g. multiple NCCs or multiple pairs of {HN, NCC}). The source gNB may transmit the allocated security information to each candidate gNB through a HANDOVER UPDATE message (S905), and each candidate gNB may transmit a HANDOVER UPDATE ACKNOWLEDGE message to the source gNB in response to the HANDOVER UPDATE message (S906). Each candidate gNB may store the security information included in the HANDOVER UPDATE message. When an inter-CU handover occurs, each candidate gNB may perform a handover procedure by applying the security information allocated for a CU to which a target cell of the terminal is connected.

The source gNB may transmit an LTM candidate cell configuration including the security information allocated by the AMF to the terminal (S907). The source gNB may include security information to be applied at the target cell in the LTM cell switch command MAC CE and transmit the LTM cell switch command MAC CE during an execution phase of the inter-CU handover. The security information included in the LTM cell switch command MAC CE may be an actual value (e.g. NCC value) of the security information allocated by the AMF, or an index value indicating a specific value among the multiple pieces of security information (e.g. an index indicating a specific entry in the list of NCC values).

In contrast, security information to be applied to the target cell may be implicitly designated. For example, when the AMF allocates one piece of security information for each CU, if a target cell for an inter-CU handover is determined and network access is attempted to the target cell, security information to be applied to the target cell may be determined as the security information allocated for a CU connected to the target cell. Alternatively, when the security information allocated for the CU connected to the target cell is identified, the corresponding security information may be processed in a predefined manner (e.g. by incrementing a NCC value by one) and used. When the AMF allocates multiple pieces of security information for each CU, the most recently unused piece of security information among those allocated for the CU connected to the target cell may be implicitly selected and used. The target cell may also apply security information by selecting the security information in the same manner as the terminal.

Unlike the method in which the source gNB requests new security information for all candidate cells from the AMF (i.e. the method of FIG. 9), in the process of preparing the LTM candidate cell configuration, each candidate gNB may individually request new security information from the AMF.

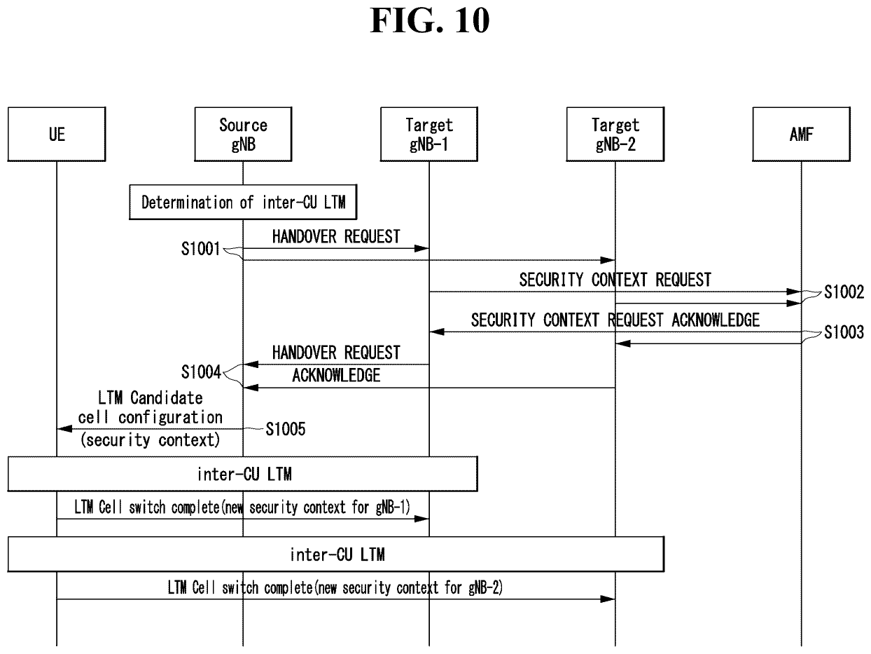

Referring to FIG. 10, each candidate gNB may request new security information from the AMF. Each of candidate gNBs that have received a HANDOVER REQUEST message from the source gNB (S1001) may transmit a SECURITY CONTEXT REQUEST message to the AMF to request new security information (S1002), and may receive the requested new security information through a SECURITY CONTEXT REQUEST ACKNOWLEDGEMENT message (S1003) . . . . Each of the candidate gNBs may include the allocated new security information along with cell configuration information in a HANDOVER REQUEST ACKNOWLEDGE message and transmit the message to the source gNB (1004). The source gNB may transmit, to the terminal, both the cell configuration information and the new security information received from each candidate gNB (S1005). The subsequent procedure is the same as the procedure in FIG. 9.

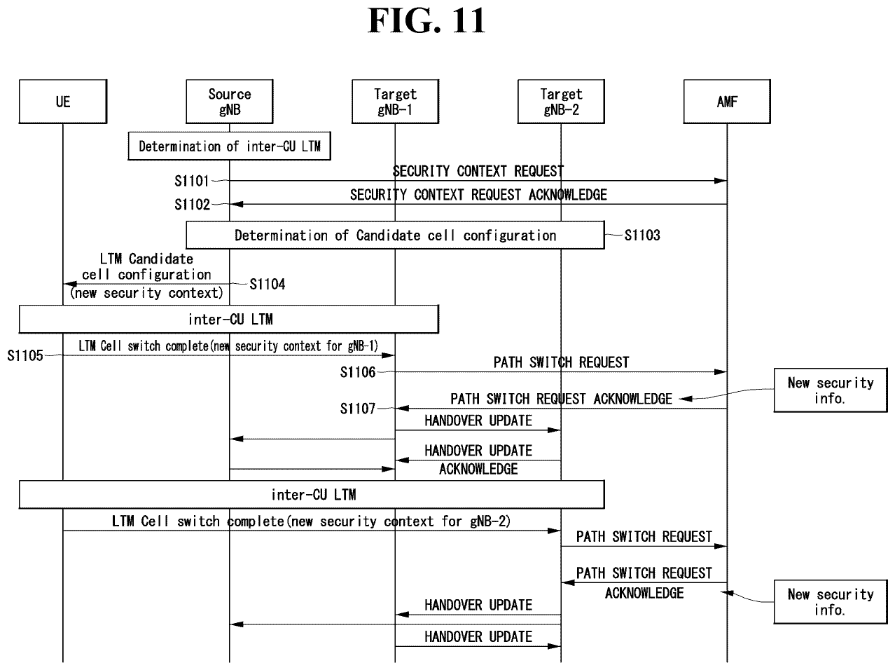

In the exemplary embodiments shown in FIGS. 9 and 10, multiple pieces of security information are pre-allocated for each candidate gNB. However, referring to FIG. 11, multiple pieces of security information may be pre-allocated based on the terminal. The source gNB that determines an inter-CU handover may transmit a SECURITY CONTEXT REQUEST message to the AMF to request security information for successive inter-CU handovers (S1101). The AMF may transmit a SECURITY CONTEXT ACKNOWLEDGE message including multiple pieces of security information for the successive inter-CU handovers to the source gNB (S1102). The source gNB may determine an LTM candidate cell configuration through signal message exchange with neighboring gNBs (S1103). The source gNB may transmit the LTM candidate cell configuration including the multiple pieces of security information allocated from the AMF to the terminal (S1104).

The source cell, at the inter-CU handover execution phase, may transmit security information to be applied to the target cell through an LTM cell switch command MAC CE (S1105). The security information included in the LTM cell switch command MAC CE may be an actual value (e.g. NCC value) of the security information allocated from the AMF, or may be an index value that designates a specific value among the multiple pieces of security information (e.g. an index that points to a specific entry in the NCC value list). The security information to be applied to the target cell may be implicitly designated. For example, the terminal may implicitly select and use the most recently unused piece of security information among the multiple pieces of security information allocated in advance. After the inter-CU handover is completed, a new source gNB may transmit a PATH SWITCH REQUEST message to the AMF to switch a downlink path (S1106), and the AMF, after switching the downlink path, may transmit a PATH SWITCH REQUEST ACKNOWLEDGE message to the source gNB (S1107). In this case, the AMF may include in the PATH SWITCH REQUEST ACKNOWLEDGE message new security information to be applied to a next inter-CU handover. The new security information included in the PATH SWITCH REQUEST ACKNOWLEDGE message may be one of the multiple pieces of security information previously allocated by the AMF to the terminal through the source cell. When the terminal implicitly selects security information to be applied to the target cell from among the multiple pieces of security information previously allocated, the AMF may be aware of a security information selection scheme used by the terminal, select security information in the same manner, and transmit the selected security information to the new source gNB. The new source gNB may use the new security information received from the AMF to generate information on a security key (e.g. gNB*) to be used in each candidate cell during a next inter-CU handover and may transmit information on the generated security key to each candidate cell.

### [LTM Candidate Cell Reference Configuration Definition]

In the inter-CU preparation phase, the LTM candidate cell configuration transmitted from the source cell to the terminal includes various information such as frequency information, system configuration information, radio connection information, and security information applied to each candidate cell. In addition, the information applied to each candidate cell may be set to the same value depending on characteristics of the cell. For example, in case of cells (DUs or TRPs) connected to the same CU, most of the information may be set to the same values, except for certain information such as identifier information and random access information. On the other hand, in case of cells (DUs or TRPs) connected to different CUs, most of the cell information may be set to different values.

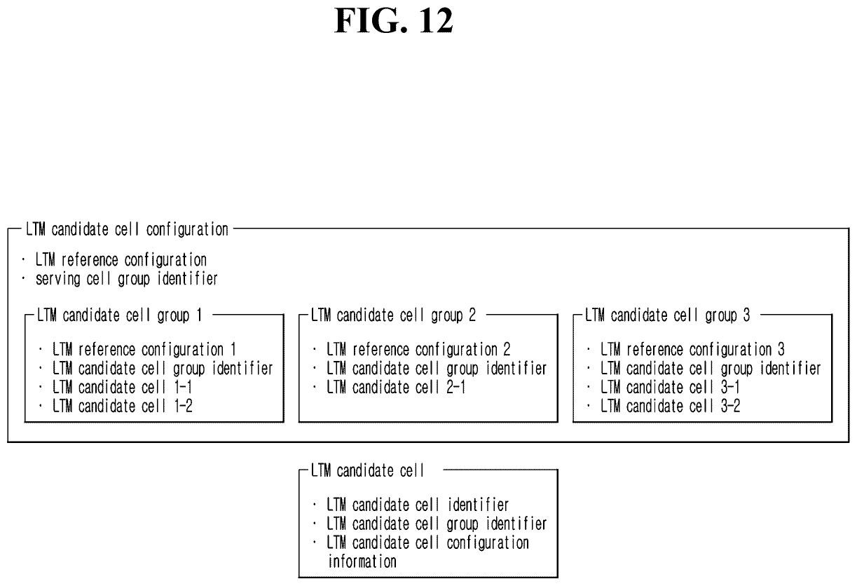

FIG. 12 is a conceptual diagram for describing a method of optimizing definition of an LTM candidate cell configuration according to an exemplary embodiment of the present disclosure.

Referring to FIG. 12, an LTM candidate cell configuration transmitted to the terminal may be defined by grouping candidate cells based on characteristics of the candidate cells. In this example, groups are simply defined based on CUs to which the respective candidate cells are connected, but the source cell may define optimized groups based on information included in each LTM candidate cell configuration. The LTM candidate cell configuration and each LTM candidate cell group (e.g. LTM candidate cell group 1, LTM candidate cell group 2, LTM candidate cell group 3) may include ‘LTM reference configuration’ parameters. The ‘LTM reference configuration’ parameters included in the LTM candidate cell configuration may indicate a reference configuration that is referred to when defining all LTM candidate cells included in the LTM candidate cell configuration, and the ‘LTM reference configuration’ parameters included in each LTM candidate cell group may indicate a reference configuration that is referred to when defining LTM candidate cells included in each LTM candidate cell group. In the example of FIG. 12, the LTM candidate cell configuration and all LTM candidate cell groups include the LTM reference configuration parameters, but the inclusion of the LTM reference configuration parameters may vary depending on how the reference configuration parameters are used. For example, the LTM candidate cell configuration may be defined such that only each LTM candidate cell group includes the LTM reference configuration parameters, and the LTM candidate cell configuration does not include the LTM reference configuration parameters. As another example, the LTM candidate cell configuration may include LTM reference configuration parameters as a master reference configuration that needs to be referred to when defining all LTM candidate cells included in the LTM candidate cell configuration, and each LTM candidate cell group may be defined to include separate LTM reference configuration parameters only when it is necessary to use a separate reference configuration to define LTM candidate cells included in each group. In other words, if an LTM candidate cell group does not include the LTM reference configuration parameters, it means that all candidate cells included in the LTM candidate cell group refer to the LTM reference configuration parameters included in the LTM candidate cell configuration to define cell configuration information.

In FIG. 12, cell group identifiers (i.e. serving cell group identifier or LTM candidate cell group identifier) included in the LTM candidate cell configuration, the LTM candidate cell group, and the LTM candidate cell are illustrated. The cell group identifier is an identifier for identifying a group to which each cell belongs. For example, when groups are designated based on CUs, a serving cell group identifier refers to a CU identifier of a CU to which a serving cell belongs, and an LTM candidate cell group identifier refers to a CU identifier of a CU to which an LTM candidate cell belongs. The CU identifier described above in [Identification of CUs and DUs] may be used as the cell group identifier. The LTM candidate cell group identifier may be included only in the LTM candidate cell group or only in the LTM candidate cell, depending on a scheme used to designate groups, and is not included in both the LTM candidate cell group and the LTM candidate cell. The terminal may determine that CUs to which the serving cell and the target cell belong are different when a serving cell group identifier of the serving cell and an LTM candidate cell group identifier of the target cell are different, and immediately performs an operation (e.g. PDCP reset) to be performed when the CU is switched after the cell switching.

Tables 1 to 3 show exemplary embodiments of the method for optimizing the definition of the LTM candidate cell configuration in the above-described environment.

Referring to Table 1, LTM candidate cell information transmitted to the terminal may be defined by grouping candidate cell information at a CU level. ltm-ReferenceConfiguration is a reference configuration that all LTM candidate cells included in the LTM candidate cell configuration need to refer to, and ltm-ServingCandidateGroupId is an identifier of a cell group to which a serving cell belongs. The LTM candidate cell configuration includes one or more ltm-CandidateGroupConfiguration, and ltm-CandidateGroupConfiguration may be configured as shown in Table 2.

Table 2 shows an exemplary embodiment of the LTM candidate group configuration. ltm-ReferenceConfiguration is a reference configuration that all LTM candidate cells included in the LTM candidate group configuration need to refer to, and ltm-CandidateGroupId is a group identifier for a group to which all LTM candidate cells included in the LTM candidate group configuration belong. ltm-CandidateToAddModList is a list of identifiers of LTM candidate cells that are newly added to the LTM candidate group configuration or that need to be changed among LTM candidate cells included in the LTM candidate group configuration. ltm-Candidate ToReleaseList is a list of identifiers of LTM candidate cells to be deleted among the previously defined LTM candidate cells included in the LTM candidate cell configuration. The LTM candidate group configuration includes one or more ltm-CandidateCell, and ltm-CandidateCell defines a cell configuration of each individual LTM candidate cell as shown in Table 3.

TABLE 1

| Parameter | Type |
|---|---|
| ltm-ReferenceConfiguration | Reference configuration to be |
| | referred to in the definition |
| | of LTM candidate cells |
| ltm-ServingCandidateGroupId | Identifier of the group to |
| | which the serving cell belongs |
| ltm-CandidateGroupConfiguration | One or more LTM candidate |
| | group configurations |

TABLE 2

| Parameter | Type |
|---|---|
| ltm-ReferenceConfiguration | Reference configuration to be referred |
| | to by all LTM candidate cells included |
| | in the LTM candidate group |
| ltm-CandidateGroupId | Group identifier of the group to which |
| | the LTM candidate cell belongs |
| ltm-CandidateToAddModList | List of LTM candidate cells newly added |
| | or to be modified in the LTM candidate |
| | group |
| ltm-CandidateToReleaseList | List of LTM candidate cells to be deleted |
| | from the LTM candidate group |
| ltm-CandidateCell | One or more LTM candidate cells |

The cell configuration of each LTM candidate cell (DU or TRP) may be defined as shown in Table 3. The LTM candidate cell includes ltm-ReferenceConfiguration, ltm-CandidateGroupId, ltm-CandidateId, ltm-CandidatePCI, and ltm-CandidateConfig. ltm-ReferenceConfiguration refers to a reference cell configuration to be referred to when defining the cell configuration of the LTM candidate cell, and may not be included depending on how the reference configuration is used. ltm-CandidateGroupId is an identifier of the cell group to which the LTM candidate cell belongs, and ltm-CandidateId is an identifier for identifying the LTM candidate cell. ltm-CandidatePCI indicates a physical cell identifier of the LTM candidate cell. ltm-CandidateConfig is the cell configuration information of the LTM candidate cell.

TABLE 3

| Parameter | Type |
|---|---|
| ltm-ReferenceConfiguration | Reference configuration to be referred |
| | to when defining an LTM candidate cell |
| ltm-CandidateGroupId | Group identifier to which the LTM |
| | candidate cell belongs |
| ltm-CandidateId | Identifier of the LTM candidate cell |
| ltm-CandidatePCI | PCI of the LTM candidate cell |
| ltm-CandidateConfig | Cell configuration information of the |
| | LTM candidate cell |

### [Inter-CU (MN) Handover in a Dual Connectivity Structure]

In a mobile communication system, carrier aggregation (CA) technology and dual connectivity (DC) technology are used to increase a transmission speed of a terminal. The CA technology is a technology in which one terminal maintains radio connections simultaneously with a plurality of cells managed by the same base station, and the DC technology is a technology in which one terminal maintains radio connections simultaneously with two base stations. In DC, a base station responsible for a primary network connection of the terminal is defined as a master node (MN), and a base station responsible for a secondary network connection is defined as a secondary node (SN). Cells within the master node connected to the terminal through CA are defined as a master cell group (MCG), and cells within a secondary node connected to the terminal through CA are defined as a secondary cell group (SCG). Among the MCG, a cell responsible for a primary connection is defined as a primary cell (PCell), and the remaining cells are defined as secondary cells (SCells). Among the SCG, a cell responsible for a primary connection is defined as a primary secondary cell (PSCell), and the remaining cells are defined as secondary cells (SCells).

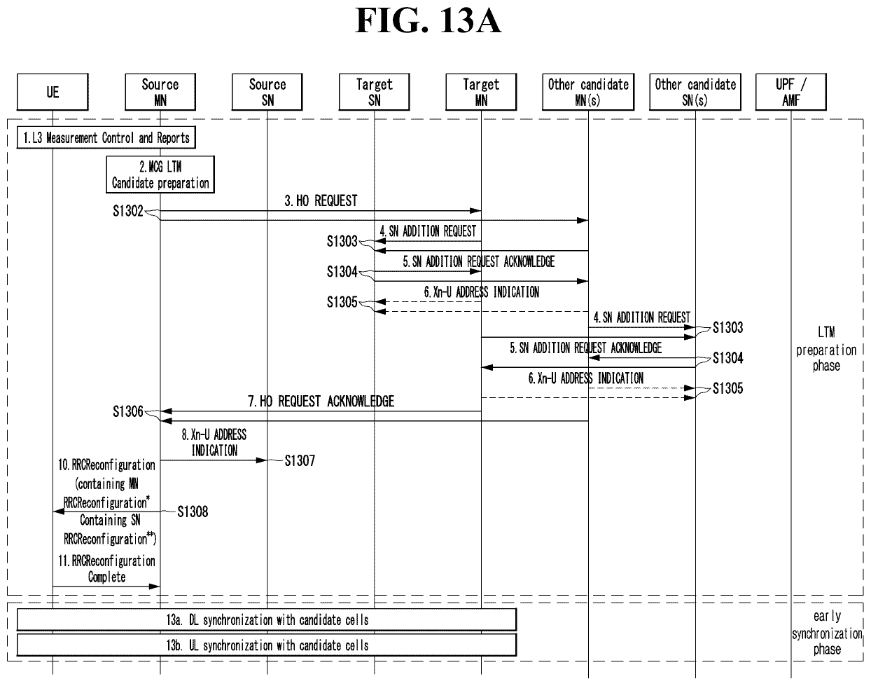

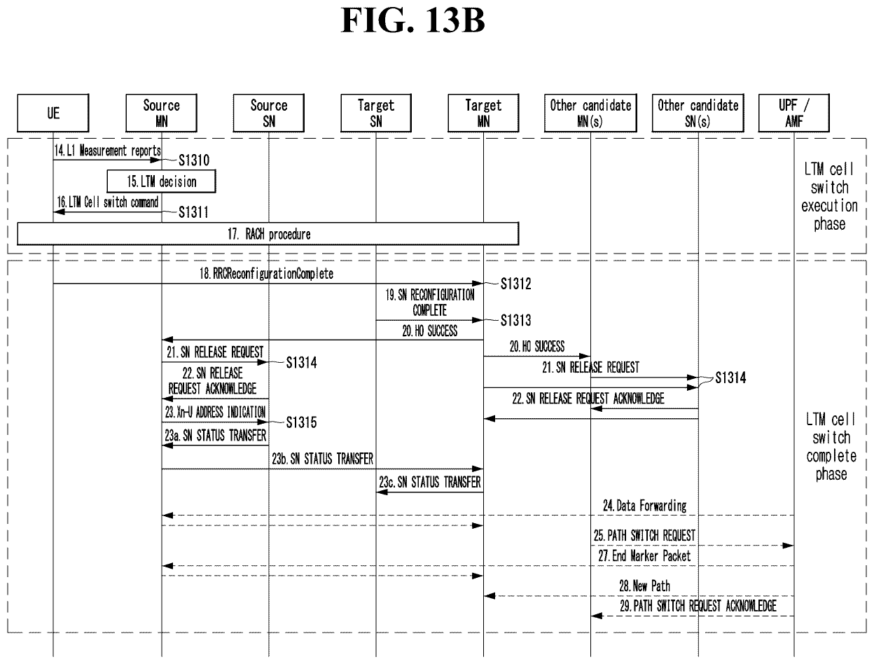

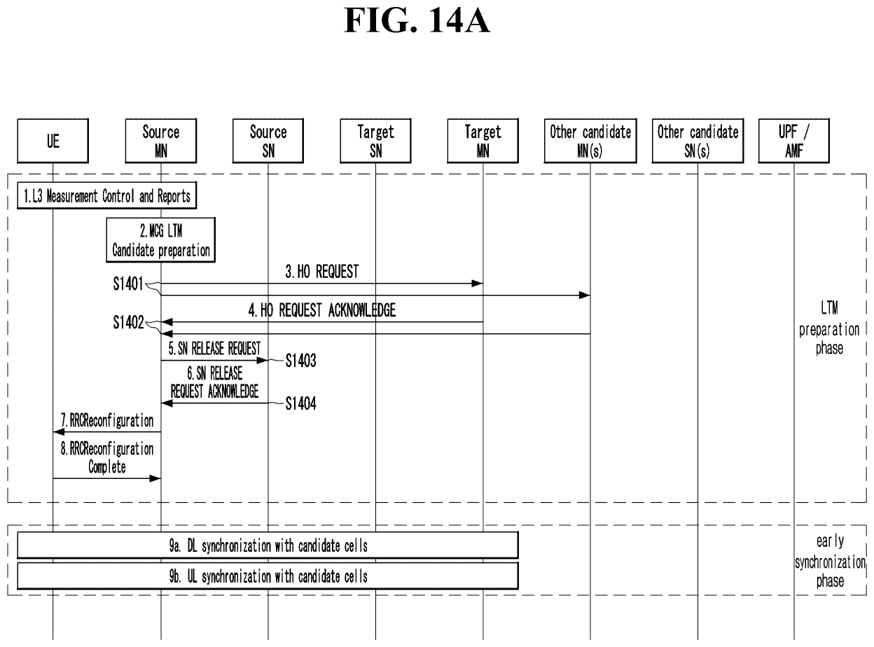

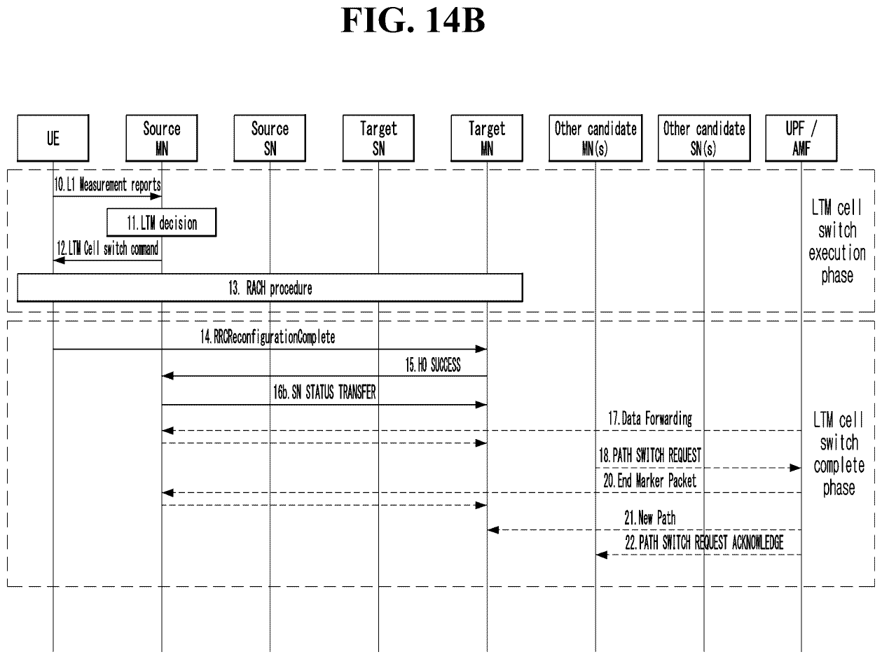

FIGS. 13A and 13B and FIGS. 14A and 14B are sequence charts for describing an inter-CU handover procedure under a condition that a CU operates as an MN according to exemplary embodiments of the present disclosure.

SN configuration and SCG configuration maintained by the terminal before a handover may be released during a handover process, or the SN and SCG configurations may be maintained in the same SN or a different SN. FIGS. 13A and 13B illustrate an inter-CU (MN) handover procedure that changes the MN while maintaining the SCG configured in the source SN when the CU is the MN. FIGS. 14A and 14B illustrate an inter-CU (MN) handover procedure that changes the MN while releasing the SCG configured in the source SN during the handover process.

Referring to FIG. 13A, the source MN may prepare an MCG LTM for switching the MN and determine candidate MNs based on radio measurement results transmitted by the terminal (S1301), and may transmit a HANDOVER REQUEST message to each candidate MN (S1302). The HANDOVER REQUEST message may include terminal information, MCG and SCG configuration information, and radio measurement results. Each candidate MN that receives the HANDOVER REQUEST message may determine whether to admit the handover and whether to maintain the SCG configuration based on the information included in the HANDOVER REQUEST message.

When determining to maintain the SN and SCG configurations, each candidate MN may transmit an SN ADDITION REQUEST message to a candidate SN to request SCG configuration (S1303), and each candidate SN may configure an SCG based on the information included in the received message and may transmit an SN ADDITION REQUEST ACKNOWLEDGE message (S1304). In this case, each candidate SN may select a plurality of candidate SCG configurations by referring to the information included in the SN ADDITION REQUEST message. For example, if the SCG configured in the source SN includes three cells and the candidate SN has five available candidate cells that can be configured as the SCG, a plurality of SCG configurations may be selected depending on combinations of selected candidate cells. When there is a connection in the SCG operated by the source SN through which the source SN transmits data to the terminal via the MCG of the MN (i.e. source SN→MN (MCG)→terminal), the candidate SN may also need to forward data to the candidate MN (i.e. candidate SN→candidate MN→terminal). To this end, each candidate MN may include a forwarding address in an Xn-U ADDRESS INDICATION message and transmit it to the candidate SN (S1305). Each candidate MN may transmit an HO REQUEST ACKNOWLEDGE message to the source MN (S1306). The HO REQUEST ACKNOWLEDGE message may include an MCG configuration to be configured in the candidate MN and an SCG configuration to be configured in the candidate SN. In addition, the HO REQUEST ACKNOWLEDGE message may include a forwarding address of each candidate SN for forwarding the downlink data of the source SN during the handover. The source MN may deliver the forwarding address included in the HO REQUEST ACKNOWLEDGE message to the source SN through an Xn-U ADDRESS INDICATION message (S1307).

The source MN may transmit an RRCReconfiguration message to the terminal to deliver the candidate cell configuration information for the MCG LTM (S1308). The RRCReconfiguration message may include MN RRCReconfiguration* including an MCG configuration for each candidate MN, and each RRCReconfiguration* may include SN RRCReconfiguration** including the candidate MN's SCG configuration for each candidate SN.

The terminal may perform a downlink and uplink synchronization procedure with the candidate MN in advance before the handover, which may be performed in the same manner as the early synchronization procedure described in FIG. 4A.

Referring to FIG. 13B, the terminal may report channel measurement results for the source MN and the candidate MN, and the source MN may determine a target MN and LTM cell switching based on the received channel measurement results (S1310). The source MN may transmit a cell switch command MAC CE to the terminal to request cell switching to the target MN (S1311). The cell switch command MAC CE may include identifier information for identifying the target MN and identifier information for identifying an SCG. The meaning of identifying an SCG is that a specific SCG configuration among a plurality of SCG configurations configured by the target SN can be identified. Therefore, the terminal may select the target MN, the target SN, and the target SCG configuration by referring to the information included in the cell switch command MAC CE.

Although not explicitly illustrated in FIGS. 13A and 13B, the source MN may transmit a separate message to the target MN immediately after transmitting the cell switch command MAC CE to inform the target MN that the terminal will soon perform cell switching to the target MN and to pre-inform the target MN of the selected SN and SCG information.

The terminal may perform random access in the manner described in FIG. 4B to access the target MN and may transmit an RRCReconfigurationComplete message to inform the target MN that the LTM cell switching has been completed (S1312). The RRCReconfigurationComplete message may include SN RRCReconfiguration information that can identify the target SN and the SCG configuration. The target MN may transmit an SN RECONFIGURATION COMPLETE message to the target SN to inform that the terminal has accessed the target MN and that data transmission and reception with the terminal and the target SN are now possible (S1313). Subsequently, the terminal may transmit an HO SUCCESS message to the source MN and the candidate MN to inform that the terminal has completed the LTM cell switching to the target MN.

In the inter-CU handover proposed in the present disclosure, even after the terminal performs cell switching, the candidate cell configuration configured for the handover may be maintained without being released. Therefore, while in a general handover procedure all candidate MN and candidate SN configurations need to be released after the handover is completed, in the present disclosure, all configurations are maintained as they are to prepare for subsequent cell switching. To this end, when the target MN transmits an SN RELEASE REQUEST message to the source SN to request the release of the SN configuration, the target MN may request different processing from a general SN release by including an indicator indicating that the current SN release request is due to the LTM handover (S1314). In a general SN release, all information regarding the terminal and cell configuration is deleted, but in the case of the LTM handover, since the source SN becomes the candidate SN after cell switching, dynamic information such as PHY/MAC timers and buffers may be deleted, but information regarding the terminal and cell configuration may be maintained. The candidate MN may also transmit an SN RELEASE REQUEST message to the candidate SN in the same manner to request the release of the SN configuration.

The source MN may transmit an Xn-U ADDRESS INDICATION message to the source SN to deliver the forwarding address for forwarding data not yet transmitted by the source SN to the target SN (S1315). The source SN may transmit an SN STATUS TRANSFER message including SN information of PDUs transmitted so far and PDUs not yet transmitted to the source MN, the source MN may deliver the message to the target MN, and the target MN may deliver the message to the target SN.

Subsequently, a procedure for switching a network path of downlink data is performed, which is the same as the network path switching procedure described in FIG. 4B. For simplification of the drawings, in FIG. 13B, the UPF and the AMF are represented as a single entity, and signaling between the UPF and the AMF is omitted.

Meanwhile, a procedure for an inter-CU (MN) handover that releases the SCG configured in the source SN without maintaining it may be possible.

Referring to FIGS. 14A and 14B, unlike in FIGS. 13A and 13B, the target MN or the candidate MN that has received the HO REQUEST message (S1401) may determine to release the SCG configuration of the source SN, and in this case, may transmit a HO REQUEST ACKNOWLEDGE message to the source MN without a separate SN configuration procedure (S1402). When maintaining the SN configuration, the HO REQUEST ACKNOWLEDGE message explicitly includes both the MCG configuration and SCG configuration, whereas when not configuring the SN, the HO REQUEST ACKNOWLEDGE message may include only the MCG configuration for the candidate MN. The source MN, which has received the HO REQUEST ACKNOWLEDGE message, may identify that the target MN has determined the release of the SCG configuration, and perform a procedure for releasing the SCG configuration of the source SN before the handover. To this end, the source MN may transmit an SN RELEASE REQUEST message to the source SN to request the release of the SCG configuration (S1403). Upon receiving the SN RELEASE REQUEST message, the source SN may stop transmitting data to the terminal, release the SCG configuration, and then transmit an SN RELEASE REQUEST ACKNOWLEDGE message to the source MN (S1404).

The handover procedure thereafter is the same as the handover procedure described in FIGS. 13A and 13B. However, since a candidate SN is not configured in the MCG LTM preparation process and the previously configured source SN is released, message exchanges with the candidate SN, the target SN, and the source SN may not occur in FIGS. 14A and 14B. For simplification of the drawings, in FIG. 14B, the UPF and the AMF are represented as a single entity, and signaling between the UPF and the AMF is omitted.

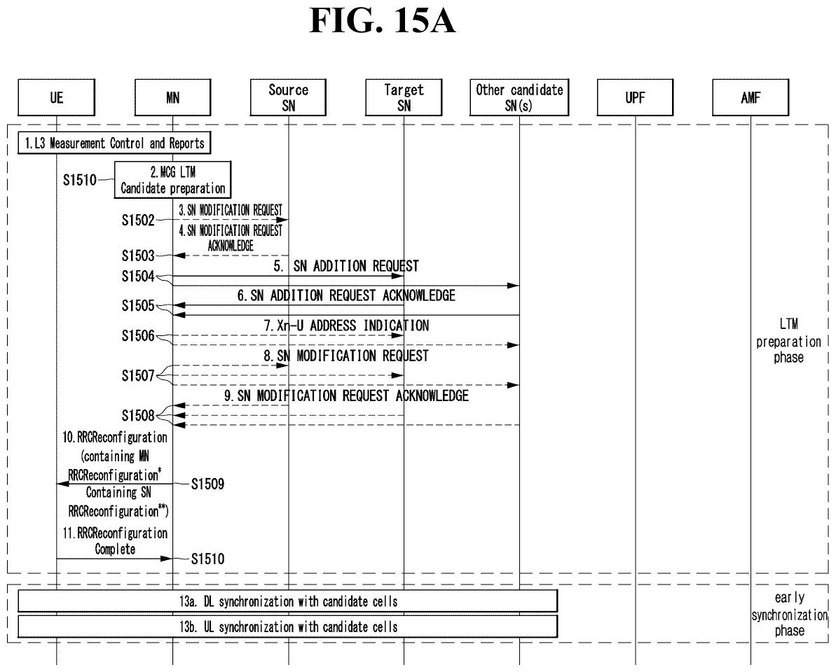

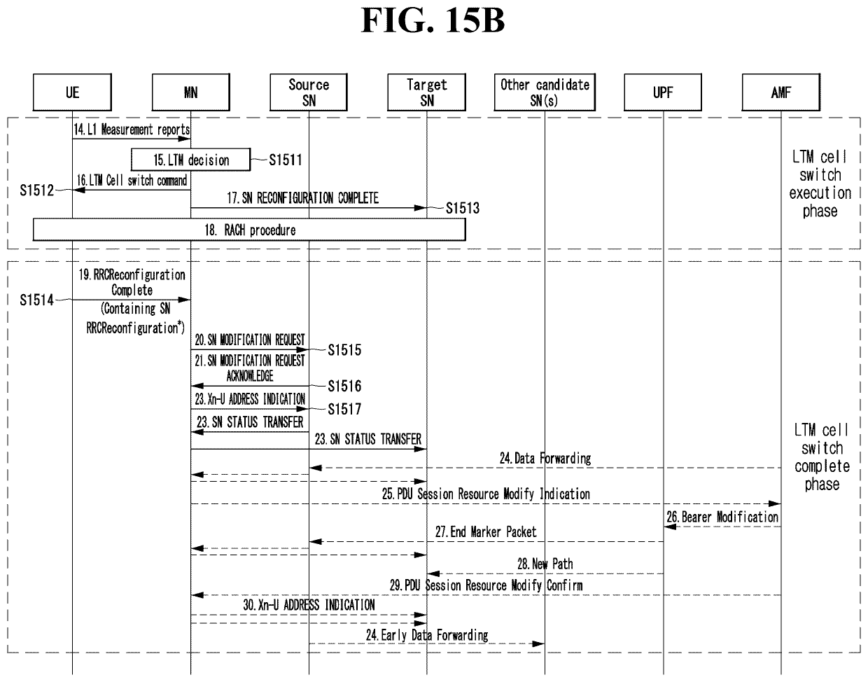

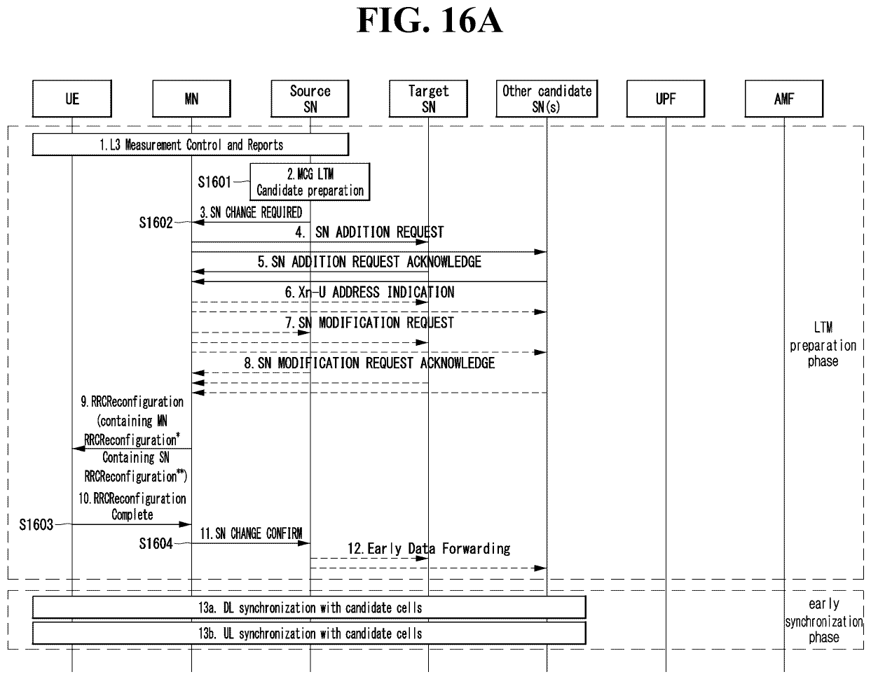

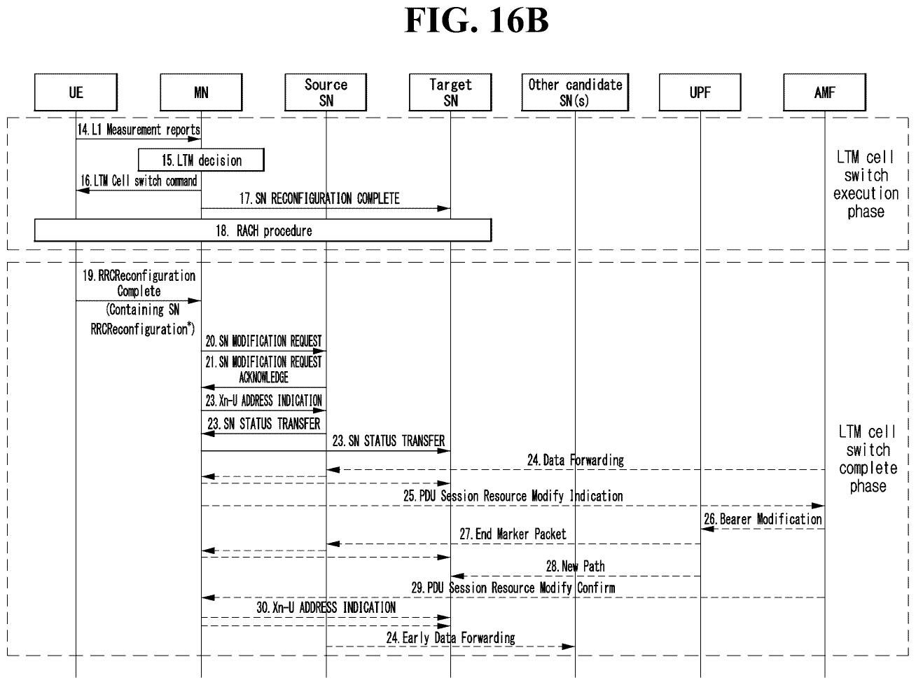

FIGS. 15A and 15B and FIGS. 16A and 16B are sequence charts for describing an inter-CU handover procedure without changing an MN under a condition that a CU operates as an SN, according to exemplary embodiments of the present disclosure.

Specifically, FIGS. 15A and 15B correspond to a case where an MN initiates a handover, and FIGS. 16A and 16B may correspond to a case where an SN initiates a handover.

Referring to FIG. 15A, the MN may determine an inter-CU (SN) handover based on layer 3 (L3) channel measurement results transmitted by the terminal, and may initiate a procedure for preparing an SCG LTM candidate cell configuration (S1501).

The MN may transmit an SN ADDITION REQUEST message to a candidate SN selected with reference to the channel measurement results to request SCG configuration (S1504). Before transmitting the SN ADDITION REQUEST message to the candidate SN, the MN may transmit an SN MODIFICATION REQUEST message to a source SN to request information on the currently configured SCG configuration (S1502), and the source SN may transmit an SN MODIFICATION REQUEST ACKNOWLEDGE message to the MN to deliver information on the current SCG configuration (S1503). The SN ADDITION REQUEST message may include information on candidate SCG cells recommended by the MN based on recent channel measurement results, and each candidate SN may select multiple candidate SCG configurations based on this information. For example, when the number of cells included in the SCG configured in the source SN is three and the candidate SN operates five cells, the candidate SN may select multiple SCG configurations depending on combinations of candidate cells for SCG configurations. The candidate SN that has selected multiple candidate cell configurations based on the terminal information and SCG configuration information included in the SN ADDITION REQUEST message may transmit an SN ADDITION REQUEST ACKNOWLEDGE message including the candidate SCG cell configurations to the MN (S1505). For a connection through which data is transmitted to the terminal via the MN among the SCG operated by the source SN, the candidate SN may also transmit data to the terminal via the MN. The MN may transmit an Xn-U ADDRESS INDICATION message to each candidate SN to provide an address for forwarding to the MN (S1506).

If some candidate SNs cannot support the same SCG configuration as that configured in the source SN, a change of the final SCG configuration may be required. In this case, the MN may transmit an SN MODIFICATION REQUEST message to the source SN and each candidate SN to notify the finally determined SCG configuration information (S1507), and the source SN and all candidate SNs may transmit SN MODIFICATION REQUEST ACKNOWLEDGE messages in response (S1508).

The MN may transmit an RRCReconfiguration message including the finally determined SCG configuration to the terminal to notify the candidate cell configuration information (S1509). The RRCReconfiguration message may include different pieces of information overlapped in the same format of the RRCReconfiguration message. The RRCReconfiguration message may include a list of RRCReconfiguration* corresponding to the respective candidate SNs, and each RRCReconfiguration* may include RRCReconfiguration** corresponding to multiple SCG configurations defined by the candidate SN. The terminal that has received the RRCReconfiguration message may store the information included in the RRCReconfiguration message and transmit an RRCReconfigurationComplete message as a response (S1510).

When the preparation for the SCG LTM candidate cell configuration is completed, data forwarding for some connections may be started. For example, for a network connection that is terminated at the source SN, data may be pre-forwarded to the candidate SN in preparation for a handover to occur later, that is, SN switching. Although not illustrated in FIGS. 15A and 15B, when data forwarding is required, the MN may transmit an Xn-U ADDRESS INDICATION message to the source SN to notify a forwarding address of the candidate SN.

When the preparation for the SCG LTM candidate cell configuration is completed, the terminal may perform a downlink and uplink synchronization procedure with the candidate SN, which may be performed in the same manner as the early synchronization procedure described in FIG. 4A.

Referring to FIG. 15B, the terminal may perform channel measurement for the candidate SN and transmit a result thereof to the MN, and the MN may determine application of a target SN and an SCG cell configuration with reference to the channel measurement result (S1511). The MN may transmit an LTM cell switch command MAC CE to the terminal to request to change the SCG cell configuration (S1512). The cell switch command MAC CE may include identifier information capable of identifying the target SN and identifier information capable of identifying the SCG. The meaning of identifying an SCG is that the target SN and a specific SCG configuration among a plurality of SCG configurations configured by the target SN can be identified. Accordingly, the terminal may refer to the information included in the cell switch command MAC CE to select the target SN and the target SCG configuration, apply the cell configuration, and then perform a random access procedure with the target SN in the manner described in FIGS. 4A and 4B. After completion of the random access, the terminal may transmit an RRCReconfigurationComplete message to the MN (S1514), and the RRCReconfigurationComplete message may include SN RRCReconfiguration information capable of identifying the target SN and the SCG configuration.

The MN that has received the RRCReconfigurationComplete message may transmit an SN RECONFIGURATION COMPLETE message to the target SN to notify that application of the SCG configuration has been completed in the terminal (S1513). In addition, the MN may transmit an SN MODIFICATION REQUEST message to the source SN to request termination of data transmission with the terminal (S1515), and may receive an SN MODIFICATION REQUEST ACKNOWLEDGE message in response (S1516). To enable data forwarding from the source SN to the candidate SN, the MN may transmit an Xn-U ADDRESS INDICATION message to notify a forwarding address (S1517), and the source SN may transmit an SN STATUS TRANSFER message including information on sequence number(s) of PDUs that have been transmitted and PDUs that have not been transmitted to the MN (S1518). The SN STATUS TRANSFER message may be delivered to the target SN via the MN, and the target SN may determine whether to terminate the data forwarding or generate SNs of new PDUs by referring to the SN STATUS TRANSFER message. The source SN that has completed data forwarding may release the SCG configuration.

In the inter-CU handover proposed in the present disclosure, there is a feature of maintaining the cell configuration configured for the handover even after the cell switching by the terminal. Therefore, the source SN may maintain terminal configuration information and cell configuration information excluding some dynamic information (e.g. PHY/MAC timers, buffers, etc.) for later cell switching, instead of deleting all terminal configuration information and SCG configuration information.

Subsequently, a procedure for switching a network path of downlink data is performed, and except for differences in names of related messages, the detailed procedure is the same as the network path switching procedure described in FIG. 4B.

Referring to FIG. 16A, the source SN may determine an inter-CU (SN) handover based on L3 channel measurement results transmitted by the terminal (S1601) and may transmit an SN CHANGE REQUIRED message to the MN to initiate a procedure for preparing SCG LTM candidate cell configuration (S1602). The SN CHANGE REQUIRED message may include a recently received channel measurement result and a candidate SN and candidate SCG cells recommended by the source SN accordingly. Upon receiving the SN CHANGE REQUIRED message, the MN may initiate a procedure for preparing the SCG LTM candidate cell, which is the same as the procedure described in FIGS. 15A and 15B.

Upon receiving an RRCReconfigurationComplete message from the terminal (S1603), the MN may transmit an SN CHANGE CONFIRM message to the source SN to notify that configuration of the SCG LTM candidate cell has been completed (S1604). Even after receiving the SN CHANGE CONFIRM message, the source SN may continue to transmit and receive data with the terminal and may pre-forward data transmitted to the terminal to the candidate SN if necessary. An actual handover decision and execution procedure thereafter may be performed in the same manner as described in FIGS. 15A and 15B.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal for an inter-centralized unit (CU) handover, comprising:
receiving candidate cell configuration information for at least one candidate cell from a source cell;
performing early uplink synchronization with the at least one candidate cell;
transmitting a layer 1 (L1) measurement report for the at least one candidate cell to the source cell;
receiving a cell switch command for a target cell among the at least one candidate cell from the source cell based on the L1 measurement report; and
performing a random access procedure for the target cell based on the cell switch command to execute the inter-CU handover,
wherein a first CU to which the source cell belongs and a second CU to which the target cell belongs are different from each other, new security information is received from the first CU or the second CU when an identifier of a serving cell group to which the source cell belongs and an identifier of a candidate cell group to which the target cell belongs are different, and at least a part of the candidate cell configuration information is maintained in the terminal after completion of the inter-CU handover.

2. The method according to claim 1, further comprising: after completion of the inter-CU handover, receiving changed candidate cell configuration information for the candidate cell configuration information from the second CU.

3. The method according to claim 2, wherein the changed candidate cell configuration information is generated by reflecting changed cell configuration information of a first candidate cell received through a HANDOVER REQUEST ACKNOWLEDGEMENT message in response to a HANDOVER REQUEST message transmitted by the second CU to the first candidate cell among the at least one candidate cell.

4. The method according to claim 2, wherein the changed candidate cell configuration information is generated by the second CU transmitting a HANDOVER CANCEL message to a first candidate cell among the at least one candidate cell and receiving a HANDOVER CANCEL ACKNOWLEDGEMENT message to delete the first candidate cell from the candidate cell configuration information.

5. The method according to claim 1, wherein the new security information is information received by the second CU from an access and mobility management function (AMF).

6. The method according to claim 1, wherein the new security information is received from the first CU by being included in a medium access control (MAC) control element (CE) which is the cell switch command.

7. The method according to claim 1, wherein the new security information is received from the second CU through a radio resource control (RRC) signaling after completion of the inter-CU handover.

8. The method according to claim 1, wherein the new security information is at least one of a next hop (NH) parameter, a next hop chaining count (NCC), or a pair of (NH, NCC).

9. The method according to claim 1, wherein the candidate cell configuration information includes at least one of information on a reference configuration commonly applied to the at least one candidate cell, information on at least one candidate cell group into which the at least one candidate cell is grouped, identifier(s) of the at least one candidate cell group, identifier(s) of the at least one candidate cell, or cell configuration information of each of the at least one candidate cell.

10. The method according to claim 9, wherein each of the identifier(s) of the at least one candidate cell group is an identifier of a CU to which each of the at least one candidate cell group belongs or an identifier assigned to each of the at least one candidate cell group.

11. The method according to claim 1, further comprising: in response to the identifier of the serving cell group to which the source cell belongs being different from the identifier of the candidate cell group to which the target cell belongs, resetting a packet data convergence protocol (PDCP) layer.

12. A method of a first centralized unit (CU) to which a source cell belongs, for an inter-CU handover, comprising:
transmitting candidate cell configuration information for at least one candidate cell to a terminal;
receiving a layer 1 (L1) measurement report for the at least one candidate cell from the terminal; and
transmitting a cell switch command for a target cell among the at least one candidate cell to the terminal based on the L1 measurement report to execute the inter-CU handover,
wherein the first CU to which the source cell belongs and a second CU to which the target cell belongs are different from each other, the first CU transmits new security information to the terminal when an identifier of a serving cell group to which the source cell belongs and an identifier of a candidate cell group to which the target cell belongs are different, and at least a part of the candidate cell configuration information is maintained in the terminal after completion of the inter-CU handover.

13. The method according to claim 12, wherein the new security information is information received by the second CU from an access and mobility management function (AMF).

14. The method according to claim 12, wherein the new security information is transmitted to the terminal by being included in a medium access control (MAC) control element (CE) which is the cell switch command.

15. The method according to claim 12, wherein the new security information is at least one of a next hop (NH) parameter, a next hop chaining count (NCC), or a pair of (NH, NCC).

16. The method according to claim 12, wherein the candidate cell configuration information includes at least one of information on a reference configuration commonly applied to the at least one candidate cell, information on at least one candidate cell group into which the at least one candidate cell is grouped, identifier(s) of the at least one candidate cell group, identifier(s) of the at least one candidate cell, or cell configuration information of each of the at least one candidate cell.

17. The method according to claim 16, wherein each of the identifier(s) of the at least one candidate cell group is an identifier of a CU to which each of the at least one candidate cell group belongs or an identifier assigned to each of the at least one candidate cell group.

18. A terminal for an inter-centralized unit (CU) handover, comprising: at least one processor, wherein the at least one processor causes the terminal to perform:
receiving candidate cell configuration information for at least one candidate cell from a source cell;
performing early uplink synchronization with the at least one candidate cell;
transmitting a layer 1 (L1) measurement report for the at least one candidate cell to the source cell;
receiving a cell switch command for a target cell among the at least one candidate cell from the source cell based on the L1 measurement report; and
performing a random access procedure for the target cell based on the cell switch command to execute the inter-CU handover,
wherein a first CU to which the source cell belongs and a second CU to which the target cell belongs are different from each other, new security information is received from the first CU or the second CU when an identifier of a serving cell group to which the source cell belongs and an identifier of a candidate cell group to which the target cell belongs are different, and at least a part of the candidate cell configuration information is maintained in the terminal after completion of the inter-CU handover.

19. The terminal according to claim 18, wherein the new security information is received from the first CU by being included in a medium access control (MAC) control element (CE) which is the cell switch command.

20. The terminal according to claim 18, wherein the at least one processor further causes the terminal to perform: in response to the identifier of the serving cell group to which the source cell belongs being different from the identifier of the candidate cell group to which the target cell belongs, resetting a packet data convergence protocol (PDCP) layer.
